(19) United States
(12) Patent Application Publication
(10) Pub. No.: US 2011/0156318 A1
(43) Pub. Date: Jun. 30, 2011

(54) RESIN COMPOSITION FOR LASER ENGRAVING, RELIEF PRINTING PLATE PRECURSOR FOR LASER ENGRAVING AND PROCESS FOR PRODUCING SAME, AND RELIEF PRINTING PLATE AND PROCESS FOR MAKING SAME

(75) Inventor: Atsushi SUGASAKI, Shizuoka (JP)

(73) Assignee: FUJIFILM Corporation, Tokyo (JP)

(21) Appl. No.: 12/977,972

(22) Filed: Dec. 23, 2010

(30) Foreign Application Priority Data
Dec. 25, 2009 (JP) 2009-296115

(51) Int. Cl. B41N 3/03; B29C 35/08

(52) U.S. Cl. 264/400

(57) ABSTRACT

A process for making a relief printing plate is provided that includes a layer formation step of forming a relief-forming layer from a resin composition that contains (Component A) a compound having a hydrolyzable silyl group and/or a silanol group and a polyurethane as (Component B) a binder polymer, a crosslinking step of crosslinking the relief-forming layer by heat and/or light to thus obtain a relief printing plate precursor having a crosslinked relief-forming layer, and an engraving step of laser-engraving the relief printing plate precursor having a crosslinked relief-forming layer to thus form a relief layer.

### TECHNICAL FIELD

The present invention relates to a resin composition for laser engraving, a relief printing plate precursor for laser engraving and a process for producing same, and a relief printing plate and a process for making same.

### BACKGROUND ART

Conventionally, a hydrophobic laser engraving type printing plate employing natural rubber, synthetic rubber, a thermoplastic elastomer, etc as binder is used (ref. e.g. U.S. Pat. No. 5,798,202). As a technique for improving the rinsing properties of engraving residue, a technique in which porous inorganic fine particles are contained in a relief-forming layer, and liquid residue is adsorbed on these particles, thus improving removability has been proposed (ref. e.g. JP-A-2004-174758 and International Patent Application WO 2009/084682 (JP-A denotes a Japanese unexamined patent application publication)).

### DISCLOSURE OF INVENTION

### Problems to be Solved by the Invention

However, as described in JP-A-2004-174758 and WO 2009/084682, addition of porous inorganic fine particles into a relief-forming layer was not sufficient for the rinsing properties of engraving residue after engraving. Moreover, the relief layer formed by engraving such relief-forming layer was not sufficient for film breaking strength and ink transfer properties.

It is an object of the present invention to provide a resin composition for laser engraving that can give a relief printing plate having excellent film breaking strength and aqueous ink transfer properties and that has excellent rinsing properties for engraving residue generated when laser-engraving a printing plate and excellent engraving sensitivity in laser engraving, a relief printing plate precursor employing the resin composition for laser engraving, a process for making a relief printing plate employing same, and a relief printing plate obtained thereby.

### Means for Solving the Problems

The above-mentioned object of the present invention has been achieved by means described in <1> below. It is described below together with <2> to <20>, which are preferred embodiments.
<1> A process for making a relief printing plate, comprising a layer formation step of forming a relief-forming layer from a resin composition comprising (Component A) a compound having a hydrolyzable silyl group and/or a silanol group and a polyurethane as (Component B) a binder polymer, a crosslinking step of crosslinking the relief-forming layer by heat and/or light to thus obtain a relief printing plate precursor having a crosslinked relief-forming layer, and an engraving step of laser-engraving the relief printing plate precursor having a crosslinked relief-forming layer to thus form a relief layer,
<2> the process for making a relief printing plate according to <1>, wherein Component A above is a compound having two or more hydrolyzable silyl groups and silanol groups,
<3> the process for making a relief printing plate according to <1> or <2>, wherein the hydrolyzable silyl group of Component A above is a residue in which at least one of an alkoxy group and a halogen atom is directly bonded to the Si atom,
<4> the process for making a relief printing plate according to any one of <1> to <3>, wherein Component A above has a group represented by Formula (1) below

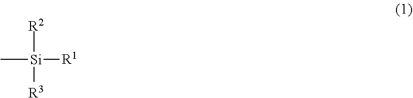

(in Formula(1), at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group, and the rest of R¹ to R³ independently denote a hydrogen atom, a halogen atom, or a monovalent organic substituent),
<5> the process for making a relief printing plate according to any one of <1> to <4>, wherein Component A above is a compound represented by Formula (A-1) or Formula (A-2) below

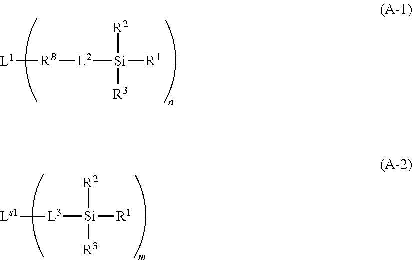

(in Formula (A-1) and Formula (A-2), R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent; in addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group),
<6> the process for making a relief printing plate according to any one of <1> to <5>, wherein Component B above is in a liquid state at 20° C.,
<7> the process for making a relief printing plate according to any one of <1> to <6>, wherein Component B above has an ethylenically unsaturated group at a polymer main chain terminus and/or in a side chain,
<8> the process for making a relief printing plate according to any one of <1> to <7>, wherein Component B above has a temperature at which the weight falls to one half of 150° C. to 450° C.,
<9> the process for making a relief printing plate according to any one of <1> to <8>, wherein the resin composition further comprises (Component C) a catalyst for promoting a decomposition reaction and/or condensation reaction of Component A above,
<10> the process for making a relief printing plate according to <9>, wherein Component C above is (Component C-1) an acidic or basic catalyst or (Component C-2) a metal complex catalyst,
<11> the process for making a relief printing plate according to any one of <1> to <10>, wherein the resin composition further comprises (Component D) a polymerizable compound,
<12> the process for making a relief printing plate according to any one of <1> to <11>, wherein the resin composition further comprises (Component E) a polymerization initiator,
<13> the process for making a relief printing plate according to any one of <1> to <12>, wherein the resin composition further comprises (Component F) a photothermal conversion agent that can absorb light having a wavelength of 700 to 1,300 nm,
<14> the process for making a relief printing plate according to any one of <1> to <13>, wherein the resin composition further comprises inorganic particles,
<15> the process for making a relief printing plate according to any one of <1> to <14>, wherein the relief printing plate precursor comprises a relief-forming layer comprising the resin composition and having a crosslinked structure obtained by reacting Component A above,
<16> the process for making a relief printing plate according to any one of <1> to <15>, wherein the relief printing plate precursor comprises a crosslinked relief-forming layer formed by crosslinking the relief-forming layer comprising the resin composition by heat and/or light,
<17> the process for making a relief printing plate according to any one of <1> to <16>, wherein the crosslinking step is a step of crosslinking the relief-forming layer by heat,
<18> the process for making a relief printing plate according to any one of <1> to <17>, wherein it further comprises a rinsing step of rinsing the engraved relief layer surface with an aqueous rinsing liquid,
<19> the process for making a relief printing plate according to any one of <1> to <18>, wherein the relief layer has a thickness of at least 0.05 mm but no greater than 10 mm, and
<20> the process for making a relief printing plate according to any one of <1> to <19>, wherein the relief layer has a Shore A hardness of at least 50° but no greater than 90°.

### MODE FOR CARRYING OUT THE INVENTION

The present invention is explained in detail below.

### (Resin Composition for Laser Engraving)

The resin composition for laser engraving used in the present invention (hereinafter, also called a ‘resin composition for laser engraving of the present invention’, ‘resin composition of the present invention’, ‘resin composition for laser engraving’ or ‘resin composition’) comprises a compound having (Component A) a hydrolyzable silyl group and/or a silanol group and polyurethane as (Component B) a binder polymer.

In the present invention, the notation ‘A to B’ expressing a numerical range means ‘at least A but no greater than B’.

Since the resin composition for laser engraving of the present invention has high engraving sensitivity when applied to laser engraving and excellent rinsing properties for engraving residue, the time taken for forming a relief layer and making a plate can be reduced. The resin composition of the present invention having such characteristics may be used without any particular limitation in a wide range of other applications in addition to a relief-forming layer of a relief printing plate precursor that is subjected to laser engraving. For example, it may be used not only in formation of a relief-forming layer of a printing plate precursor for which formation of a raised relief is carried out by laser engraving, which is described in detail later, but also in formation of another material form in which asperities or apertures are formed on the surface, for example, various types of printing plates or various types of moldings in which an image is formed by laser engraving, such as an intaglio plate, a stencil plate, or a stamp.

Among them, a preferred embodiment is use in formation of a relief-forming layer provided on an appropriate support.

In the present specification, when a relief printing plate precursor is explained, a layer that comprises the binder polymer (Component B), that serves as an image-forming layer subjected to laser engraving, that has a flat surface, and that is an uncrosslinked crosslinkable layer is called a relief-forming layer, a layer that is formed by crosslinking the relief-forming layer is called a crosslinked relief-forming layer, and a layer that has asperities formed on the surface by laser engraving the crosslinked relief-forming layer is called a relief layer.

Constituent components of the resin composition for laser engraving are explained below.

<(Component A) Compound Having Hydrolyzable Silyl Group and/or Silanol Group>

The ‘hydrolyzable silyl group’ of (Component A) a compound having a hydrolyzable silyl group and/or a silanol group (hereinafter, called ‘Component A’ as appropriate) used in the resin composition for laser engraving of the present invention is a silyl group that is hydrolyzable; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (1) below.

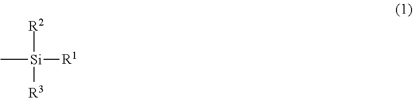

In Formula (1) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group. The remainder of R¹ to R³ independently denote a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component A in the present invention is preferably a compound having one or more groups represented by Formula (1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component A is preferably at least 2 but no greater than 6, and most preferably 2 or 3.

A range of 1 to 4 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group as the hydrolyzable group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

Component A preferably has at least a sulfur atom, an ester bond, a urethane bond, an ether bond, a urea bond, or an imino group.

Among them, from the viewpoint of crosslinkability, Component A preferably comprises a sulfur atom, and from the viewpoint of removability (rinsing properties) of engraving residue, it is preferable for it to comprise an ester bond, a urethane bond, or an ether bond (in particular, an ether bond contained in an oxyalkylene group), which is easily decomposed by aqueous alkali.

Furthermore, from the viewpoint of alkali rinsing properties of engraving residue, engraving sensitivity, and breaking strength, Component A in the present invention is preferably a compound not having a (meth)acryloyl group, more preferably a compound not having an ethylenically unsaturated group, and yet more preferably a compound not having a curable functional group other than a hydrolyzable silyl group and/or a silanol group. That is, in the present invention, from the viewpoint of alkali rinsing properties of engraving residue, engraving sensitivity, and breaking strength, it is preferable that for Component A only a hydrolyzable silyl group and/or a silanol group function as a curable functional group (crosslinkable group).

As Component A in the present invention, there can be cited a compound in which a plurality of groups represented by Formula (1) above are bonded via a divalent linking group, and from the viewpoint of the effect, such a divalent linking group is preferably a linking group having a sulfide group (—S—), an imino group (—N(R)—) or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing Component A is not particularly limited, and synthesis can be carried out by a known method. As one example, a representative synthetic method for a Component A containing a linking group having the above-mentioned specific structure is shown below.

<Synthetic Method for Compound Having Sulfide Group as Linking Group and Having Hydrolyzable Silyl Group and/or Silanol Group>

A synthetic method for a Component A having a sulfide group as a linking group (hereinafter, called as appropriate a ‘sulfide linking group-containing Component A’) is not particularly limited, but specific examples thereof include reaction of a Component A having a halogenated hydrocarbon group with an alkali metal sulfide, reaction of a Component A having a mercapto group with a halogenated hydrocarbon, reaction of a Component A having a mercapto group with a Component A having a halogenated hydrocarbon group, reaction of a Component A having a halogenated hydrocarbon group with a mercaptan, reaction of a Component A having an ethylenically unsaturated double bond with a mercaptan, reaction of a Component A having an ethylenically unsaturated double bond with a Component A having a mercapto group, reaction of a compound having an ethylenically unsaturated double bond with a Component A having a mercapto group, reaction of a ketone with a Component A having a mercapto group, reaction of a diazonium salt with a Component A having a mercapto group, reaction of a Component A having a mercapto group with an oxirane, reaction of a Component A having a mercapto group with a Component A having an oxirane group, reaction of a mercaptan with a Component A having an oxirane group, and reaction of a Component A having a mercapto group with an aziridine.

<Synthetic Method for Compound Having Imino Group as Linking Group and Having Hydrolyzable Silyl Group and/or Silanol Group>

A synthetic method for a Component A having an imino group as a linking group (hereinafter, called as appropriate an ‘imino linking group-containing Component A’) is not particularly limited, but specific examples include reaction of a Component A having an amino group with a halogenated hydrocarbon, reaction of a Component A having an amino group with a Component A having a halogenated hydrocarbon group, reaction of a Component A having a halogenated hydrocarbon group with an amine, reaction of a Component A having an amino group with an oxirane, reaction of a Component A having an amino group with a Component A having an oxirane group, reaction of an amine with a Component A having an oxirane group, reaction of a Component A having an amino group with an aziridine, reaction of a Component A having an ethylenically unsaturated double bond with an amine, reaction of a Component A having an ethylenically unsaturated double bond with a Component A having an amino group, reaction of a compound having an ethylenically unsaturated double bond with a Component A having an amino group, reaction of a compound having an acetylenically unsaturated triple bond with a Component A having an amino group, reaction of a Component A having an imine-based unsaturated double bond with an organic alkali metal compound, reaction of a Component A having an imine-based unsaturated double bond with an organic alkaline earth metal compound, and reaction of a carbonyl compound with a Component A having an amino group.

<Synthetic Method for Compound Having Urea Bond (Ureylene Group) as Linking Group and Having Hydrolyzable Silyl Group and/or Silanol Group>

A synthetic method for Component A having an ureylene group (hereinafter, called as appropriate a ‘ureylene linking group-containing Component A’) as a linking group is not particularly limited, but specific examples include synthetic methods such as reaction of a Component A having an amino group with an isocyanate ester, reaction of a Component A having an amino group with a Component A having an isocyanate ester, and reaction of an amine with a Component A having an isocyanate ester.

Component A is preferably a compound represented by Formula (A-1) or Formula (A-2) below.

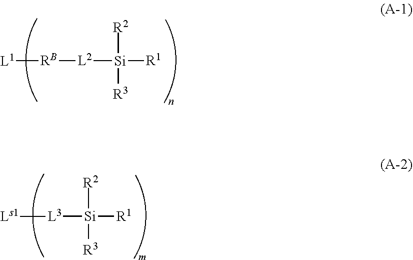

(In Formula (A-1) and Formula (A-2), R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent. In addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.)

R¹ to R³ in Formula (A-1) and Formula (A-2) above have the same meanings as those of R¹ to R³ in Formula (1) above, and preferred ranges are also the same.

From the viewpoint of rinsing properties and film strength, R^{B} above is preferably an ester bond or a urethane bond, and is more preferably an ester bond.

The divalent or n-valent linking group denoted by L¹ to L³ above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L¹ to L³ above is preferably 2 to 60, and more preferably 2 to 30.

The m-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

n and m above are independently preferably integers of 1 to 10, more preferably integers of 2 to 10, yet more preferably integers of 2 to 6, and particularly preferably 2.

From the viewpoint of removability (rinsing properties) of engraving residue, the n-valent linking group denoted by L¹ and/or the divalent linking group denoted by L², or the divalent linking group denoted by L³ preferably has an ether bond, and more preferably has an ether bond contained in an oxyalkylene group.

Furthermore, L^{s1} and L³ above preferably do not have an ester bond, an amide bond, a urethane bond, a urea bond, or an imino group.

Among compounds represented by Formula (A-1) or Formula (A-2), from the viewpoint of crosslinkability, etc., the n-valent linking group denoted by L¹ and/or the divalent linking group denoted by L² in Formula (A-1) are preferably groups having a sulfur atom.

Specific examples of Component A that can be applied to the present invention are shown below. Examples thereof include vinyltrichiorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, N-2-(aminoethyl)-γ-aminopropyltriethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, tris-(3-trimethoxysilylpropyl)isocyanurate, γ-chloropropyltrimethoxysilane, γ-ureidopropyltriethoxysilane, trimethylsilanol, diphenylsilanediol, triphenylsilanol, γ-triethoxysilylpropyl(meth)acrylate, and hexyltrimethoxysilane. Other than the above, the compounds shown below can be cited as preferred examples, but the present invention should not be construed as being limited thereto.

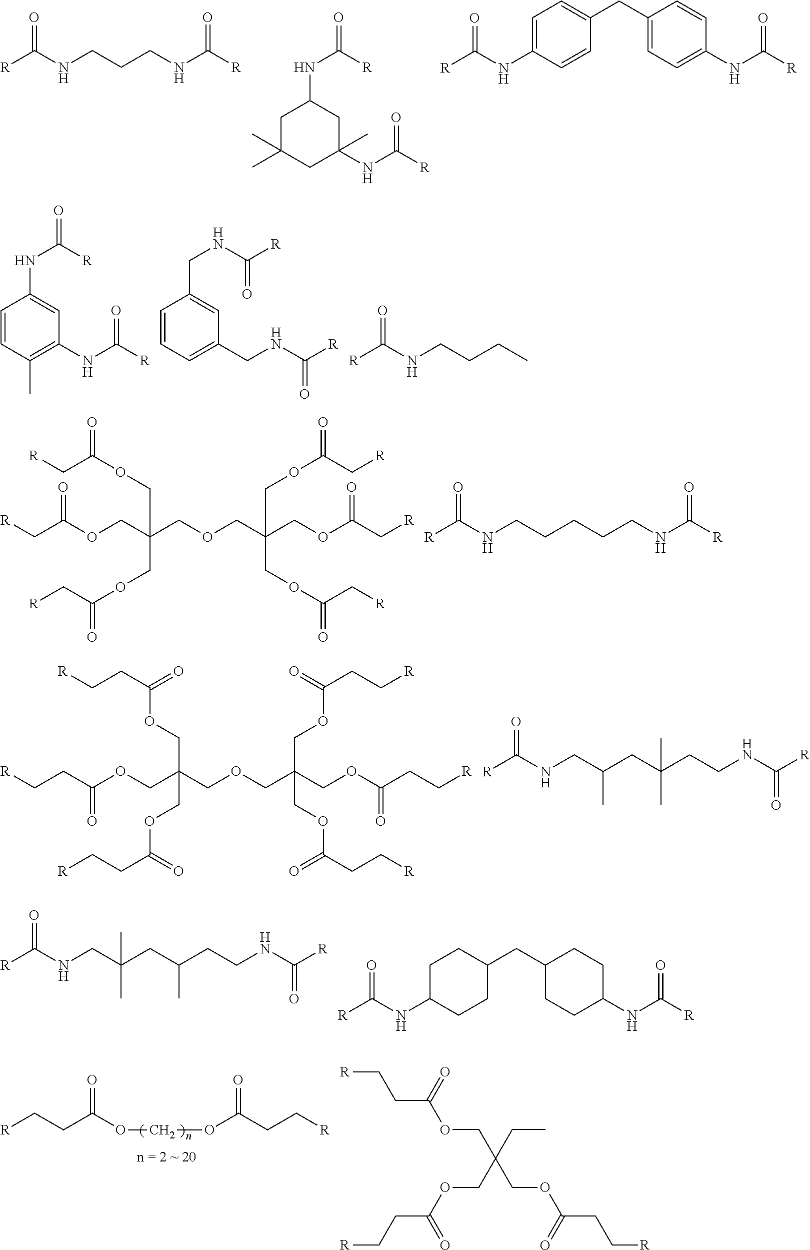

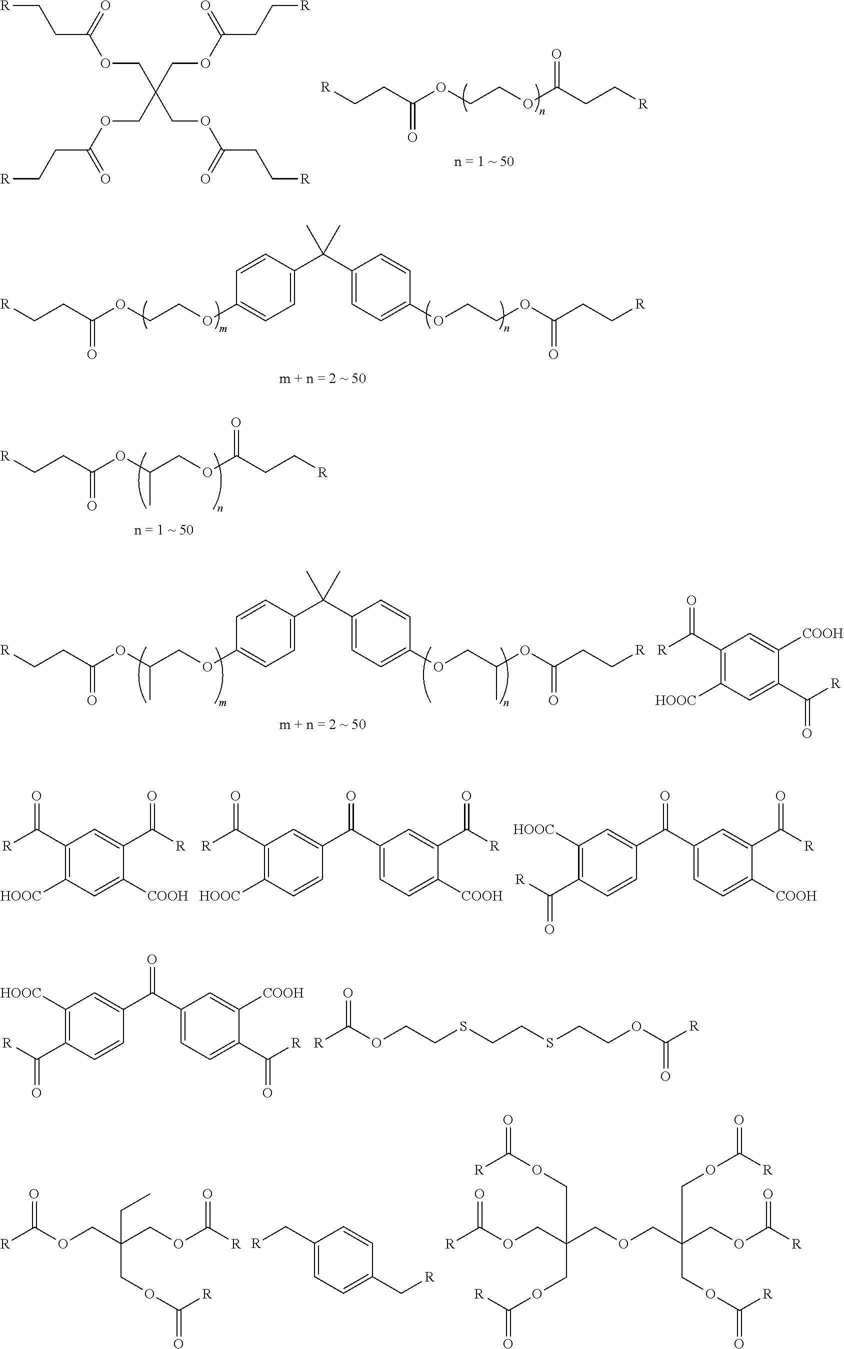

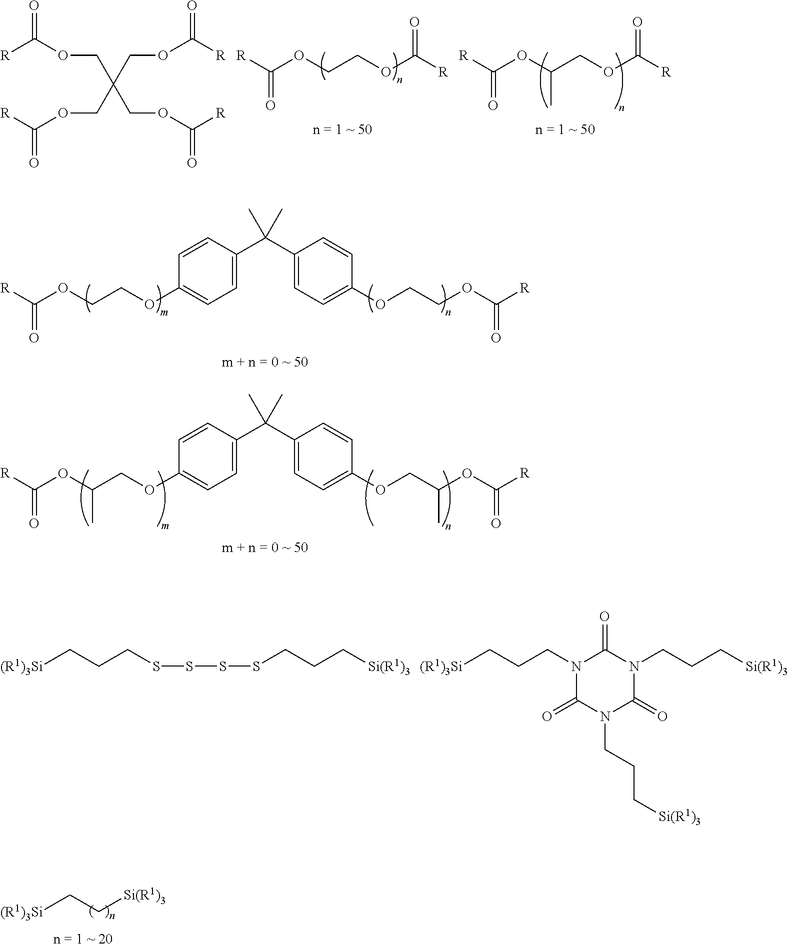

In each of the formulae above, R denotes a partial structure selected from the structures below. When a plurality of Rs and R¹s are present in the molecule, they may be identical to or different from each other, and are preferably identical to each other in terms of synthetic suitability.

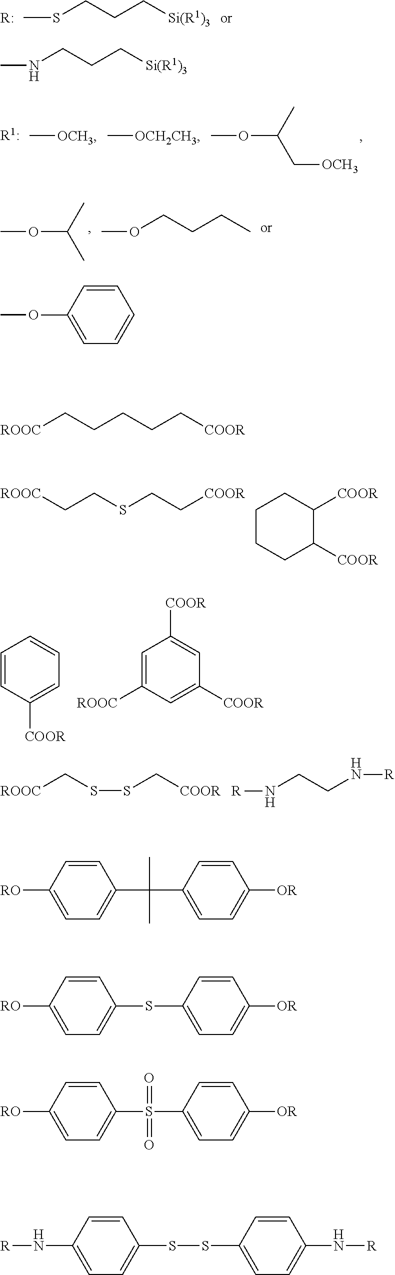

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

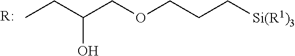

Component A may be obtained by synthesis as appropriate, but use of a commercially available product is preferable in terms of cost. Since Component A corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As Component A in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is desirable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

With regard to Component A in the resin composition of the present invention, only one type may be used or two or more types may be used in combination.

The content of Component A contained in the resin composition of the present invention is preferably in the range of 0.1 to 80 weight % on a solids content basis, more preferably in the range of 1 to 40 weight %, and most preferably in the range of 5 to 30 weight %.

### <(Component B) Binder Polymer>

The resin composition for laser engraving of the present invention comprises a polyurethane as (Component B) a binder polymer (hereinafter, called ‘Component B’ as appropriate).

In accordance with combining Component A and Component B, the film breaking strength and aqueous ink suitability (resistance) improve. It is surmised that improvement of the film breaking strength is due to formation of a pseudo-crosslinked structure by multiple point hydrogen bonding between an alkoxysilyl group of Component A and a urethane bond contained in Component B. It is also surmised that improvement of the aqueous ink suitability is due to high affinity with an aqueous ink since a urethane bond of Component B is itself relatively highly polarized (hydrophilic).

A polyurethane is a polymer obtained by a reaction between a polyol and a polyisocyanate. Here, the polyol is a compound having two or more hydroxy groups and the polyisocyanate is a compound having two or more isocyanato groups (—NCO).

Examples of the polyol include a low-molecular-weight polyol, a polyester polyol, a polyether polyol, a polybutadienediol, a hydrogenated polybutadienediol, and a polycarbonate polyol, and the molecular weight and chemical structure may be changed in various ways.

As the polyisocyanate, an aliphatic, aromatic, or alicyclic compound may be used.

As the polyurethane used as the Component B binder polymer, it is preferable to use a polyester polyurethane obtained by a reaction between the polyester polyol and the polyisocyanate, a polyhydrogenated polybutadiene polyurethane obtained by a reaction between the hydrogenated polybutadiene polyol and the polyisocyanate, or a polycarbonate polyurethane obtained by a reaction between the polycarbonate polyol and the polyisocyanate, and it is more preferable to use a polycarbonate polyurethane.

From the viewpoint of rinsing properties of engraving residue, Component B preferably has a polar group such as a carboxy group in a side chain, and more preferably has a carboxy group in a side chain. Introducing a hydrogen-bonding polar group such as a carboxy group into a molecule enables interaction between polyurethanes or interaction with inorganic particles (e.g. a silanol group on the surface of silica particles) used as a preferred mode of the present invention to be increased, thus consequently improving the film breaking strength when used as a flexographic printing plate.

Furthermore, an unsaturated group-containing polyurethane may preferably be used in the present invention, and a polyurethane having an ethylenically unsaturated group at a polymer molecular terminus or in a side chain may more preferably be used. Details are described later.

The polyurethane used as Component B preferably has a number-average molecular weight of at least 1,000 but no greater than 300,000, more preferably at least 5,000 but no greater than 200,000, and yet more preferably at least 10,000 but no greater than 100,000. When the number-average molecular weight of the polyurethane is in the above-mentioned range, the crosslinked relief-forming layer can maintain strength, and durability that can withstand repeated use as a relief printing plate can be obtained. At the same time, the viscosity of the resin composition for laser engraving does not increase excessively, and a complicated processing method such as thermal extrusion is not required when preparing a sheet-form or cylinder-form resin cured material.

In the present invention, ‘number-average molecular weight’ is a value obtained by measurement using gel permeation chromatography (GPC) and is converted by calibration using polystyrene having a known molecular weight.

The polyurethane used as Component B preferably has a glass transition temperature of no greater than 20° C., and is preferably in a liquid state at 20° C.

The content of the polyurethane contained in the resin composition of the present invention is preferably in the range of 10 to 90 wt % of the total solids content by weight of the resin composition, more preferably in the range of 30 to 80 wt %, and yet more preferably in the range of 40 to 75 wt %. When in the above-mentioned range, it is possible for a relief-forming layer to have suitable mechanical properties.

Specific examples of a compound preferred as the polyurethane include a compound having in the molecular skeleton a polycarbonate polyurethane obtained by a reaction between an aliphatic polycarbonate diol and a diisocyanate compound, and a compound further having a polymerizable unsaturated group such as a (meth)acrylate residue at a molecular terminus is preferable.

Examples of the aliphatic polycarbonate diol include poly(ethylene carbonate)diol, poly(butylene carbonate)diol, poly(pentamethylene carbonate)diol, poly(hexamethylene carbonate)diol, poly((1,9-nonanediol; 2-methyl-1,8-octanediol)carbonate)diol, a polymer having 1,3-dioxan-2-one and 1,6-hexanediol regions, and a polymer having dimethyl carbonate and 1,6-hexanediol regions and a 2-oxepanone region.

Examples of commercial products of compounds having a carbonate bond in the molecule include PCDL (registered trademark) ‘L4672’, ‘T5651’, ‘T6002’, ‘T5652’, ‘T5650J’, and ‘T4671’ (all from Asahi Kasei Chemicals Corporation), Kuraray Polyol (registered trademark) ‘C-2015N’ (Kuraray Co., Ltd.), Placcel CD (registered trademark) ‘CD205’, ‘CD205PL’, ‘CD205HL’, ‘CD210’, ‘CD210PL’, ‘CD220’, and ‘CD220PL’ (all from Daicel Chemical Industries, Ltd.), and ETERNACOLL (registered trademark) ‘UH’, ‘UHC’, ‘UC’, and ‘UM’ (all from Ube Industries, Ltd.).

As the diisocyanate compound, an aliphatic, aromatic, or alicyclic diisocyanate may be used, and examples thereof include 2,4-tolylene diisocyanate, 2,6-tolylene diisocyanate, 4,4′-diphenylmethane diisocyanate, hexamethylene diisocyanate, isophorone diisocyanate, methylenebis(cyclohexane-1,4-diyl)diisocyanate, m-phenylenebis(1-methylethane-1,1-diyl)diisocyanate, hexamethylene diisocyanate, m-xylylenediyl diisocyanate, naphthalene-1,5-diyl diisocyanate, 1,6-diisocyanato-2,2,4-trimethylhexane, 3,3′-dimethylbiphenyl-4,4′-diisocyanate, 1,3-phenylene diisocyanate, 1,4-phenylene diisocyanate, cyclohexane-1,3-diyl diisocyanate, cyclohexane-1,4-diyl diisocyanate, dimer acid diisocyanate, cyclohexane-1,3-diylbis(methyl isocyanate), 2-methyl-1,4-phenylene diisocyanate, 4-[(2-isocyanatophenyl)oxy]phenyl isocyanate, 4,4′-oxybis(phenyl isocyanate), naphthalene 1,4-diyl diisocyanate, naphthalene-2,6-diyl diisocyanate, naphthalene-2,7-diyl isocyanate, 1-methylcyclohexane 2,4-diisocyanate, 2,2′-dimethoxybiphenyl-4,4′-diyl diisocyanate, methyl 2,6-diisocyanatohexanoate, 5-methyl-1,3-phenylene diisocyanate, methylenebis(2,1-phenylene)diisocyanate, 4-[(2-isocyanatophenyl)methyl]phenyl isocyanate, dimethyldiisocyanatosilane, 2,4,6-triisopropylbenzene-1,3-diyl diisocyanate, 2,2-dimethylpentane-1,5-diyl diisocyanate, 4-[(2-isocyanatophenyl)thio]phenyl isocyanate, undecamethylene diisocyanate, methylenebis(2-methyl-4,1-phenylene)diisocyanate, adipoyl isocyanate, 4,4′-ethylenebis(1-isocyanatobenzene), 1-(trifluoromethyl)-2,2,2-trifluoroethylidenebis(4,1-phenylene) diisocyanate, tetramethylene diisocyanate, 1,4-phenylenebis(ethylene), diisocyanate, 1,4-phenylenebis(ethylene)diisocyanate, 1-methylethylene diisocyanate, methylene diisocyanate, sulfonylbis(3,1-phenylene)diisocyanate, ethylene diisocyanate, trimethylene diisocyanate, pentamethylene diisocyanate, heptane-1,7-diyl diisocyanate, nonamethylene diisocyanate, and decamethylene diisocyanate.

As a compound for introducing a polymerizable unsaturated group such as a (meth)acrylate group into a molecular terminus of a Component B polyurethane, there can be cited a compound having in the molecule a functional group such as a (meth)acrylate group or a vinyl group as a polymerizable unsaturated group as well as a functional group such as a hydroxy group, an isocyanate group, an amino group, or a carboxy group.

From the viewpoint of reactivity, specific preferred examples of such a compound include 2-(meth)acryloyloxy isocyanate and 2-hydroxyethyl (meth)acrylate. These compounds enable a (meth)acrylate group to be introduced into a polyurethane molecular terminus by an addition reaction with a polyurethane having a hydroxy group or isocyanato group respectively.

When a flexible relief layer is required, as with application to a flexographic printing plate, in the resin composition for laser engraving of the present invention it is preferable to add as Component B, in addition to a polyurethane, a liquid-form resin having a glass transition temperature of no greater than 20° C., and it is more preferable to add a liquid-form resin having a glass transition temperature of no greater than 0° C. Examples of such a liquid-form resin include hydrocarbons such as polyethylene, polybutadiene, hydrogenated polybutadiene, polyisoprene, and hydrogenated polyisoprene; polyesters such as an adipate and polycaprolactone; polyethers such as polyethylene glycol, polypropylene glycol, and polytetramethylene glycol; an aliphatic polycarbonate, silicones such as polydimethylsiloxane; polymers of (meth)acrylic acid and/or derivatives thereof, mixtures thereof, and copolymers thereof.

It is preferable for the content of the liquid-form resin to be 30 to 60 wt % relative to the entire Component B.

It is preferable to use as a polyurethane one having high thermal decomposability. As an index for thermal decomposability, data of a thermogravimetric analysis method obtained by measuring decrease in weight when heating a sample in an inert gas atmosphere may be used.

From the viewpoint of thermal decomposability, as a polyurethane one for which the temperature at which the weight falls to one half is in the range of 150° C. to 450° C. is preferable, one for which it is in the range of 180° C. to 350° C. is more preferable, and one for which it is in the range of 200° C. to 330° C. is yet more preferable. Furthermore, a polyurethane for which thermal decomposition occurs in a narrow range of temperature is preferable since thermal decomposition products dissipate well and the engraving speed increases further. As an index thereof, the difference between the temperature at which the weight decreases to 80% of the initial weight and the temperature at which the weight decreases to 20% of the initial weight in the above thermogravimetric analysis is preferably no greater than 100° C., more preferably no greater than 80° C., and yet more preferably no greater than 60° C.

The polyurethane used as Component B preferably has in the molecule a polymerizable unsaturated group, more preferably has an ethylenically unsaturated group, and yet more preferably has an ethylenically unsaturated group at a polymer main chain terminus and/or in a side chain.

In the present specification, ‘having a polymerizable unsaturated group in the molecule’ means a polymerizable unsaturated group chemically bonded directly to a polymer main chain terminus, a polymer side chain terminus, or a polymer main chain or side chain.

The polyurethane preferably has on average at least 0.7 polymerizable unsaturated groups per molecule. It is desirable that the number of polymerizable unsaturated groups is on average at least 0.7 per molecule since a resin cured material has excellent mechanical strength and good durability and, in particular, is resistant to repeated use as a printing substrate.

When the mechanical strength of a resin cured material is taken into consideration, the number of polymerizable unsaturated groups of the polyurethane is preferably at least 0.7 per molecule, and more preferably at least 1.

The upper limit for the number of polymerizable unsaturated groups per molecule is not particularly limited but is preferably no greater than 20. When there are no greater than 20 polymerizable unsaturated groups per molecule, shrinkage during thermal curing can be suppressed, and the occurrence of cracks in the vicinity of the surface can also be suppressed.

As a method for introducing a polymerizable unsaturated group into a polyurethane, for example, a method in which a polymerizable unsaturated group is directly introduced into a molecular terminus or side chain of a polyurethane can be cited.

As an alternative method, the following method can be cited. Firstly, a compound having a plurality of reactive groups such as hydroxy groups, amino groups, epoxy groups, carboxy groups, acid anhydride groups, ketone groups, hydrazine residues, isocyanate groups, isothiocyanate groups, cyclic carbonate groups, or ester groups is reacted with a binder having a plurality of functional groups that can form a bond with the reactive groups (e.g. a polyisocyanate in the case of a hydroxy group or an amino group), thus carrying out control of the molecular weight and exchange with a terminal bonding group. Subsequently, the compound obtained by the reaction is reacted with a compound having a polymerizable unsaturated group and a functional group that reacts with the terminal bonding group of the compound, thus introducing a polymerizable unsaturated group into the molecular terminus by a polymer reaction.

In the resin composition of the present invention, the mechanism of action due to the combined use of Component A, which is a hydrolyzable silyl group- and/or silanol group-containing compound, and a polyurethane as Component B is surmised to be as follows.

In a film of the resin composition, a self-condensation reaction of Component A, which is a hydrolyzable silyl group- and/or silanol group-containing compound, is partially progressed by moisture in the film, thus forming a crosslinked structure due to Component A. As a result, there are (I) an effect of improving rinsing properties due to engraving residue formed by laser engraving turning from a liquid state into a powder state and becoming removable not only when washed with an alkaline washing liquid but also when merely rinsed with tap water and (II) an effect of resistance to plastic deformation due to improved breaking strength and elasticity of the film when formed using the resin composition. The effect (II) of improved breaking strength and elasticity of the film also brings about an effect of improving ink transfer properties and printing durability of a printing plate formed when the resin composition of the present invention has application as a relief-forming layer.

When an alkaline washing liquid is used as a rinsing liquid, since the urethane bond of Component B is hydrolyzed to form a hydrophilic alcohol when rinsing with an alkaline washing liquid, it is surmised that this alcohol (the hydrophilicity thereof) assists the rinsing properties.

Furthermore, in a preferred mode of the present invention, when a divalent linking group that links a plurality of groups represented by Formula (1) above of Component A has a heteroatom, there is (III) an effect of increasing engraving sensitivity due to this heteroatom, and the sensitivity improvement effect is particularly remarkable when an S atom is contained as the heteroatom.

With regard to the effect (I) of improving rinsing properties, it is thought that a crosslinked structure is formed by a self-condensation reaction of Component A, the self-condensation product of Component A is hydrolyzed by a washing liquid, in particular an alkali washing liquid, and forms a silanol group, and as a result engraving residue containing the self-condensation product (thermal decomposition product thereof) becomes hydrophilic, thus improving the rinsing properties. It is surmised that in the alkali washing liquid, a silanol group thus formed behaves as an acidic group and is neutralized by the alkali, thus improving the rinsing properties.

Moreover, when Component A has a linking group having a heteroatom bonding to a carbon in the molecule, the carbon atom adjacent to the heteroatom is in an electronic state in which covalent electrons are biased toward the heteroatom and is energetically easily cleaved. It is thought that, as a result, it is easily thermally decomposed by laser engraving and (III) engraving sensitivity improves.

With regard to the effect (II) of improving film breaking strength and elasticity, it is thought to be as follows.

First of all, with regard to improvement of film breaking strength, it is surmised that a self-condensation reaction of Component A partially proceeds and a high strength Si—O-containing network structure having so-called glass-like properties is formed. In the present invention, a polyurethane is used as Component B. A polyurethane has a large number of hydrogen-bonding urethane bonds. Since such a urethane bond forms a hydrogen bond with an alkoxysilyl group or silanol group of Component A, Component A and Component B are mixed uniformly at the molecular level, that is, Component A and Component B are miscible with each other. It is surmised that such miscibility between Component A and Component B is one factor in improving the film breaking strength.

Furthermore, improvement of film elasticity is thought to be due to exhibition of rubber elasticity due to the following mechanism. That is, a polyurethane as Component B behaves as a soft segment because of its relatively low glass transition temperature. On the other hand, a self-condensation product of Component A and, furthermore, a polymerizable compound of Component D, which is described later, behave as bridging points (so-called hard segments). In this way, a film formed using the resin composition satisfies the condition of having both a hard segment and a soft segment, which is a requirement for being a rubber, and as a result the film exhibits rubber elasticity. It is thought that the ink transfer properties of the film improve as a result of the improvement in film elasticity due to rubber elasticity being exhibited as above; for example, the efficiency with which ink that has been transferred from an anilox roller onto the film is transferred onto a printed material improves.

Furthermore, the resin composition for laser engraving of the present invention may comprise in combination a known binder polymer in addition to a polyurethane.

The content of Component B is preferably 5 to 95 weight % relative to the total solids content by weight of the resin composition for laser engraving, more preferably 15 to 80 weight %, and yet more preferably 20 to 65 weight %.

For example, when the resin composition for laser engraving of the present invention is applied to a relief-forming layer of a relief printing plate precursor, by setting the content of Component B at 5 weight % or greater, printing durability that enables a resulting relief printing plate to be used satisfactorily as a printing plate is obtained, and by setting it at 95 weight % or less, flexibility that enables a relief printing plate to be used satisfactorily as a printing plate when applied to a flexographic printing plate is obtained without making other components insufficient.

### <(Component C) Catalyst>

The resin composition of the present invention preferably comprises (Component C) a catalyst for promoting a decomposition reaction and/or condensation reaction of Component A (hereinafter, called ‘Component C’ as appropriate). Component C may be used without any restrictions as long as it is a reaction catalyst generally used in a silane coupling reaction. Hereinafter, (Component C-1) an acidic or basic catalyst and (Component C-2) a metal complex catalyst, which are representative catalysts that can be used as Component C, are explained in sequence.

### (Component C-1) Acidic or Basic Catalyst

As the catalyst, an acidic or basic compound is used as it is or in the form of a solution in which it is dissolved in a solvent such as water or an organic solvent (hereinafter, called an acidic catalyst or basic catalyst respectively). The concentration when dissolving in a solvent is not particularly limited, and it may be selected appropriately according to the properties of the acidic or basic compound used, desired catalyst content, etc.

Examples of the acidic catalyst include a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a substituted carboxylic acid in which R of the structural formula RCOOH is substituted with another element or substituent, a sulfonic acid such as benzenesulfonic acid, phosphoric acid, a heteropoly acid, and an inorganic solid acid.

Examples of the basic catalyst include an ammoniacal base such as aqueous ammonia, an amine, an alkali metal hydroxide, an alkali metal alkoxide, an alkaline earth oxide, a quaternary ammonium salt compound, and a quaternary phosphonium salt compound.

Examples of the amine include (a) a hydrogenated nitrogen compound such as hydrazine; (b) an aliphatic amine, alicyclic amine or aromatic amine; (c) a condensed ring-containing cyclic amine; (d) an oxygen-containing amine such as an amino acid, an amide, an alcoholamine, an ether amine, an imide or a lactam; and (e) a heteroelement-containing amine having a heteroatom such as S or Se.

As the aliphatic amine (b), an amine compound represented by Formula (C-1) is preferable.

N(R^{d1})(R^{d2})(R^{d3}) (C-1)

In Formula (C-1), R^{d1} to R^{d3} independently denote a hydrogen atom, a straight-chain or branched alkyl group having 1 to 10 carbon atoms, a cycloalkyl group having 5 to 10 carbon atoms, an aryl group having 6 to 20 carbon atoms, or a 3- to 10-membered sulfur atom- or oxygen atom-containing heterocycle (thiophene), and the alkyl group and cycloalkyl group may have at least one unsaturated bond.

The amine compound represented by Formula (C-1) may have a substituent, and examples of the substituent include an alkyl group having 1 to 10 carbon atoms, an aryl group having 6 to 20 carbon atoms, an amino group, a (di)alkylamino group having an alkyl group having 1 to 6 carbon atoms, and a hydroxy group.

Two or more groups among R^{d1} to R^{d3} above may be bonded to form a C═N bond. Examples of an amine compound having a C═N bond include guanidine and 1,1,3,3-tetramethylguanidine.

Examples of the alicyclic amine (b) include an alicyclic amine in which a ring skeleton, where two or more groups among R^{d1} to R^{d3} in a compound represented by Formula (C-1) above are bonded, contains a nitrogen atom. Examples of the alicyclic amine include pyrrolidine, piperidine, piperazine, and quinuclidine.

Examples of the aromatic amine (b) include imidazole, pyrrole, pyridine, pyridazine, pyrazine, purine, quinoline, and quinazoline. The aromatic amine may have a substituent, and examples of the substituent include substituents described for Formula (C-1).

Furthermore, two or more identical or different aliphatic amines, alicyclic amines, or aromatic amines may be bonded to form a polyamine such as a diamine or a triamine. The polyamine is preferably a polyamine in which aliphatic amines are bonded, and examples thereof include hexamethylenetetramine and polyethyleneimine.

The condensed ring-containing cyclic amine (c) is a cyclic amine in which at least one nitrogen atom is contained in a ring skeleton forming a condensed ring; examples thereof include 1,8-diazabicyclo[5.4.0]undec-7-ene, 1,5-diazabicyclo[4.3.0]non-5-ene, and 1,4-diazabicyclo[2.2.2]octane, and among them 1,8-diazabicyclo[5.4.0]undec-7-ene is preferable.

Examples of the oxygen-containing amine (d) such as an amino acid, an amide, an alcoholamine, an ether amine, an imide, or a lactam include phthalimide, 2,5-piperazinedione, maleimide, caprolactam, pyrrolidone, morpholine, glycine, alanine, and phenylalanine.

In addition, (c) and (d) may have the substituent described for a compound represented by Formula (C-1), and among them an alkyl group having 1 to 6 carbon atoms is preferable.

As the amine compound in the present invention, (b) and (c) are preferable. As (b), an aliphatic amine is preferable, a polyamine of an aliphatic amine is more preferable, and polyethyleneimine is yet more preferable. As (c), 1,8-diazabicyclo[5.4.0]undec-7-ene is preferable.

From the viewpoint of film strength after thermal crosslinking, a preferred pKaH (acid dissociation constant of conjugated acid) range for the amine is preferably 7 or greater, and more preferably 10 or greater.

Among the above-mentioned acidic catalysts and basic catalysts, from the viewpoint of a decomposition reaction and/or condensation reaction of Component A in the film progressing promptly, methanesulfonic acid, p-toluenesulfonic acid, pyridinium p-toluenesulfonate, dodecylbenzenesulfonic acid, phosphoric acid, phosphonic acid, acetic acid, 1,8-diazabicyclo[5.4.0]undec-7-ene, 1,5-diazabicyclo[4.3.0]non-5-ene, and 1,1,3,3-tetramethylguanidine are preferable, and methanesulfonic acid, p-toluenesulfonic acid, phosphoric acid, 1,8-diazabicyclo[5.4.0]undec-7-ene, and 1,5-diazabicyclo[4.3.0]non-5-ene are particularly preferable.

### (Component C-2) Metal Complex Catalyst

The metal complex catalyst (Component C-2) used as a catalyst (Component C) in the present invention is one formed from a metal element selected from Groups 2A, 3B, 4A, and 5A of the periodic table and an oxo or hydroxy oxygen compound selected from a β-diketone, a ketoester, a hydroxycarboxylic acid or an ester thereof, an amino alcohol, and an enolic active hydrogen compound.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti (ethyl orthotitanate, etc.) is excellent and preferable.

In the present invention, examples of the oxo or hydroxy oxygen-containing compound forming a ligand of the metal complex include β-diketones such as acetylacetone (2,4-pentanedione) and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid, and methyl tartarate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methylmonoethanolamine, diethanolamine, and triethanolamine, enolic active compounds such as methylolmelamine, methylolurea, methylolacrylamide, and diethyl malonate, and compounds having a substituent on the methyl group, methylene group, or carbonyl carbon of acetylacetone (2,4-pentanedione).

A preferred ligand is an acetylacetone derivative, and the acetylacetone derivative in the present invention means a compound having a substituent on the methyl group, methylene group, or carbonyl carbon of acetylacetone. The substituent with which the methyl group of acetylacetone is substituted is a straight-chain or branched alkyl group, acyl group, hydroxyalkyl group, carboxyalkyl group, alkoxy group, or alkoxyalkyl group having 1 to 3 carbon atoms, the substituent with which the methylene carbon of acetylacetone is substituted is a carboxy group or a straight-chain or branched carboxyalkyl group or hydroxyalkyl group having 1 to 3 carbon atoms, and-the substituent with which the carbonyl carbon of acetylacetone is substituted is an alkyl group having 1 to 3 carbon atoms, and in this case the carbonyl oxygen turns into a hydroxy group by addition of a hydrogen atom.

Specific preferred examples of the acetylacetone derivative include acetyl acetone, ethylcarbonylacetone, n-propylcarbonylacetone, i-propylcarbonylacetone, diacetylacetone, 1-acetyl-1-propionylacetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol. Among them, acetylacetone and diacetylacetone are particularly preferable. The complex of the acetylacetone derivative and the metal element is a mononuclear complex in which 1 to 4 molecules of acetylacetone derivative coordinate to one metal element, and when the number of coordinatable sites of the metal element is larger than the total number of coordinatable bond sites of the acetylacetone derivative, a ligand that is usually used in a normal complex, such as a water molecule, a halide ion, a nitro group, or an ammonio group, may coordinate thereto.

Preferred examples of the metal complex include a tris(acetylacetonato)aluminum complex salt, a di(acetylacetonato)aluminum-aquo complex salt, a mono(acetylacetonato)aluminum-chloro complex salt, a di(diacetylacetonato)aluminum complex salt, ethyl acetoacetate aluminum diisopropylate, aluminum tris(ethyl acetoacetate), cyclic aluminum oxide isopropylate, a tris(acetylacetonato)barium complex salt, a di(acetylacetonato)titanium complex salt, a tris(acetylacetonato)titanium complex salt, a di-i-propoxy-bis(acetylacetonato)titanium complex salt, zirconium tris(ethyl acetoacetate), and a zirconium tris(benzoic acid) complex salt. They are excellent in terms of stability in an aqueous coating solution and an effect in promoting gelling in a sol-gel reaction when thermally drying, and among them ethyl acetoacetate aluminum diisopropylate, aluminum tris(ethyl acetoacetate), a di(acetylacetonato)titanium complex salt, and zirconium tris(ethyl acetoacetate) are particularly preferable.

The resin composition of the present invention may employ only one type of Component C or two or more types thereof in combination.

The content of Component C in the resin composition is preferably 0.01 to 20 weight % in the total solids content of a relief-forming layer, and more preferably 0.1 to 10 weight %.

### <(Component D) Polymerizable Compound>

In the present invention, from the viewpoint of forming a crosslinked structure in a relief-forming layer, in order to form this structure it is preferable for the resin composition for laser engraving of the present invention to comprise (Component D) a polymerizable compound (hereinafter, called ‘Component D’ as appropriate).

The polymerizable compound that can be used here may be selected freely from compounds having at least one ethylenically unsaturated group, preferably at least two, more preferably two to six, and yet more preferably two. Furthermore, the polymerizable compound is a compound that is different from Component B and is preferably a compound having an ethylenically unsaturated bond at a molecular terminal. Moreover, the molecular weight (weight-average molecular weight) of the polymerizable compound is preferably less than 5,000.

The polymerizable compound is not particularly limited; known compounds may be used, and examples include those described in paragraphs 0098 to 0124 of JP-A-2009-204962.

A monofunctional monomer having one ethylenically unsaturated bond in the molecule and a polyfunctional monomer having two or more of said bonds in the molecule, which are used as Component D, are explained below.

Since it is necessary to form a crosslinked structure in a relief-forming layer of the relief printing plate precursor for laser engraving in the present invention, a polyfunctional monomer is preferably used. The molecular weight of these polyfunctional monomers is preferably 120 to 3,000, and more preferably 200 to 2,000.

Examples of the monofunctional monomer and polyfunctional monomer include an ester of an unsaturated carboxylic acid (e.g. acrylic acid, methacrylic acid, itaconic acid, crotonic acid, isocrotonic acid, maleic acid, etc.) and a polyhydric alcohol compound and an amide of an unsaturated carboxylic acid and a polyvalent amine compound.

From the viewpoint of improving engraving sensitivity, it is preferable in the present invention to use as Component D a compound having a sulfur atom in the molecule.

As such a polymerizable compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —C—S—, —C—SS—, —NH(C═S)O—, —NH(C═O)S—, —NH(C═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the sulfur-containing polyfunctional monomer molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

Moreover, examples of the polymerizable compound having a sulfur atom in the molecule include those described in JP-A-2009-255510.

In accordance with the use of a polymerizable compound such as a sulfur-containing polyfunctional monomer in the resin composition of the present invention, it is possible to adjust film physical properties such as brittleness and flexibility of a crosslinked relief-forming layer of a lithographic printing plate precursor for laser engraving.

Furthermore, from the viewpoint of flexibility or brittleness of a crosslinked film, the content of the polymerizable compound (Component D) in the resin composition for laser engraving of the present invention is preferably 5 to 60 weight % on a solids content basis, and more preferably 8 to 30 weight %.

### <(Component E) Polymerization Initiator>

When the resin composition for laser engraving of the present invention is used for preparing a relief-forming layer, it preferably further comprises (Component E) a polymerization initiator (hereinafter, called Component E as appropriate), and it is preferable to use this in combination with the polymerizable compound (Component D).

As the polymerization initiator, a radical polymerization initiator is preferable. Examples of the radical polymerization initiator include an aromatic ketone, an onium salt compound, an organic peroxide, a thio compound, a hexaarylbiimidazole compound, a ketoxime ester compound, a borate compound, an azinium compound, a metallocene compound, an active ester compound, a carbon-halogen bond-containing compound, and an azo-based compound. Among them, from the viewpoint of engraving sensitivity and good relief edge shape when applied to a relief-forming layer of a relief printing plate precursor, an organic peroxide and an azo-based compound are preferable, and an organic peroxide is particularly preferable.

As the polymerization initiator, preferred examples thereof include compounds described in paragraphs 0074 to 0118 of JP-A-2008-63554.

Furthermore, as a compound that is preferably used in combination, since use of an organic peroxide and a photothermal conversion agent in combination greatly increases the engraving sensitivity, it is most preferable to employ a mode in which an organic peroxide and carbon black, which is a photothermal conversion agent, are used in combination.

This is because, when a relief-forming layer is cured by thermal crosslinking using an organic peroxide, unreacted organic peroxide that is not involved in radical formation remains, but the remaining organic peroxide functions as a self-reactive additive and decomposes exothermically during laser engraving. It is surmised that, as a result, an amount corresponding to the heat generated is added to the irradiated laser energy, and the engraving sensitivity is thus increased.

This effect is outstanding when carbon black is used as a photothermal conversion agent. It is surmised that, as a result of heat generated from carbon black being transmitted to an organic peroxide, heat is generated not only from the carbon black but also from the organic peroxide, and thermal energy that is used for decomposition of Component B, etc. is generated synergistically.

With regard to Component E in the present invention, one type may be used on its own or two or more types may be used in combination.

The content of Component E in the resin composition for laser engraving of the present invention is preferably 0.01 to 10 weight % relative to the total solids content by weight of the relief-forming layer, and more preferably 0.1 to 3 weight %. When the content of the polymerization initiator is at least 0.01 weight %, an effect from the addition thereof is obtained, and crosslinking of a crosslinkable relief-forming layer proceeds promptly. Furthermore, when the content is no greater than 10 weight %, other components do not become insufficient, and printing durability that is satisfactory as a relief printing plate is obtained.

### <(Component F) Photothermal Conversion Agent>

The resin composition for laser engraving of the present invention preferably comprises (Component F) a photothermal conversion agent (hereinafter, called ‘Component F’ as appropriate). It is surmised that the photothermal conversion agent absorbs laser light and generates heat thus promoting thermal decomposition of a cured material of the resin composition for laser engraving of the present invention. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the relief-forming layer in the present invention to comprise a photothermal conversion agent that has a maximun absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples include pigments described in paragraphs 0122 to 0125 of JP-A-2009-178869. Preferred examples of these pigments include carbon black.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples include of carbon black described in paragraphs 0130 to 0134 of JP-A-2009-178869.

The content of the photothermal conversion agent in the resin composition for laser engraving of the present invention largely depends on the size of the molecular extinction coefficient characteristic to the molecule, and is preferably 0.01 to 30 wt % relative to the total weight of the solids content of the resin composition, more preferably 0.05 to 20 wt %, and yet more preferably 0.1 to 10 wt %.

### <Inorganic Particles>

The resin composition for laser engraving of the present invention may comprise inorganic particles.

Adding inorganic particles enables improvement of the mechanical properties of a resin cured material (crosslinked relief-forming layer) obtained by curing, improvement of the wettability of the surface of a resin cured material, adjustment of the viscosity of the resin composition for laser engraving, adjustment of the viscoelasticity of the resin cured material, etc. Adding inorganic particles to the resin composition comprising Component A and Component B enables reduction of tack of the surface of a resin cured material, improvement of the rinsing properties of engraving residue, and improvement of print quality by a relief printing plate to be achieved. Furthermore, the use of Component A and inorganic particles in combination enables the breaking strength of a film formed from a resin cured material to be improved and can give a relief printing plate having excellent ink transfer properties.

The material of the inorganic particles is not particularly limited, and a known material may be used.

For the purpose of improving the mechanical properties of a resin cured material, it is preferable to use inorganic particles having high rigidity such as silicon nitride, boron nitride, or silicon carbide.

It is also possible to add inorganic particles for the purpose of improving the solvent resistance of a resulting resin cured material.

It is preferable, for the purpose of forming by a laser engraving method a pattern that pierces the surface of a resin cured material layer or a resin cured material, to add porous inorganic particles having a number-average particle size of at least 5 nm but no greater than 10 μm or nonporous inorganic particles having a primary particle number-average particle size of at least 5 nm but no greater than 100 nm, both of which have excellent adsorptive removal properties for tacky liquid residue formed during laser engraving.

Here, ‘porous inorganic particles’ in the present invention means inorganic particles having a pore volume of at least 0.1 mL/g. In the present invention, pore volume is obtained from a nitrogen adsorption isotherm at −196° C. by a nitrogen adsorption method.

The pore volume of the porous inorganic particles is preferably in the range of at least 0.1 mL/g but no greater than 10 mL/g, and more preferably at least 0.2 mL/g but no greater than 5 mL/g. When porous inorganic particles having a pore volume of at least 0.1 mL/g are used, the amount of adsorption of tacky liquid residue formed during laser engraving becomes sufficient. When the pore volume is no greater than 10 mL/g, it is possible to ensure that the porous inorganic particles have mechanical strength.

The number-average particle size of the porous inorganic particles is preferably at least 100 nm but no greater than 10 μm, and more preferably at least 300 nm but no greater than 5 μm.

The porous inorganic particles are not particularly limited, but examples thereof include porous silica, mesoporous silica, silica-zirconia porous gel, porous alumina, and porous glass.

With regard to the porous inorganic particles, one type thereof or two or more types thereof in combination may be used.

Furthermore, ‘nonporous inorganic particles’ in the present invention means microparticles having a pore volume of less than 0.1 mL/g.

The number-average particle size of the nonporous inorganic particles is preferably at least 10 nm but no greater than 100 nm, and more preferably at least 10 nm but no greater than 50 nm.

As a material for the nonporous inorganic particles, for example, at least one type selected from alumina, silica, zirconium oxide, barium titanate, strontium titanate, titanium oxide, silicon nitride, boron nitride, silicon carbide, chromium oxide, vanadium oxide, tin oxide, bismuth oxide, germanium oxide, aluminum borate, nickel oxide, molybdenum oxide, tungsten oxide, iron oxide, and cerium oxide is preferably contained as a main component.

The nonporous inorganic particles are preferably nonporous inorganic particles produced using the above-mentioned material by any one of a flame hydrolysis method, an arc method, a plasma method, a precipitation method, a gelling method, and a molten solid method. The flame hydrolysis method, the arc method, and the plasma method are also called thermal decomposition methods or high temperature methods (dry methods). The precipitation method and the gelling method are also called wet methods. Among them, a dry method and, in particular, a flame hydrolysis method is preferable.

With regard to the nonporous inorganic particles, one type or two or more types thereof in combination may be used, and they may be used in combination with the porous inorganic particles.

When porous or nonporous inorganic particles having a number-average particle size in the above-mentioned range are used, there are no problems such as increase in viscosity, inclusion of bubbles, or formation of a large amount of dust when mixing a binder polymer and a polymerizable compound, and the surface of a resin cured material will not have unevenness.

The number-average particle size of inorganic particles may be measured using a laser-scattering type particle size distribution analyzer. The number-average particle size of inorganic particles in the present specification is a value measured using a laser-scattering type particle size distribution analyzer.

The particle shape of the inorganic particles is not particularly limited, and particles having a spherical form, a flat form, an acicular form, an amorphous form, or projections on the surface may be used. From the viewpoint of abrasion resistance in particular, spherical particles are preferable.

It is also possible to subject the surface of inorganic particles to a surface modification treatment by coating with a silane coupling agent, a titanium coupling agent, or another organic compound, thus making particles hydrophilic or hydrophobic. With regard to these inorganic particles, one type or two or more types thereof may be selected.

When inorganic particles are used in the resin composition for laser engraving of the present invention, they are preferably at least 1 part by weight but no greater than 100 parts by weight relative to 100 parts by weight of Component B, more preferably at least 2 parts by weight but no greater than 50 parts by weight, and yet more preferably at least 2 parts by weight but no greater than 20 parts by weight.

### <Solvent>

From the viewpoint of dissolving and mixing a relatively hydrophobic starting material and a somewhat high polarity starting material with good balance, a solvent used when preparing the resin composition for laser engraving of the present invention is preferably mainly an aprotic organic solvent. The aprotic organic solvent may be used on its own or may be used in combination with a protic organic solvent. More specifically, they are used preferably at aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

### <Other Additives>

The resin composition for laser engraving of the present invention preferably comprises a plasticizer. The plasticizer has the function of softening a film formed from the resin composition for laser engraving and is preferably one that is compatible with a binder polymer.

Examples of the plasticizer that are preferably used include dioctyl phthalate, didodecyl phthalate, a polyethylene glycol, and polypropylene glycol (monool type or diol type).

The resin composition for laser engraving of the present invention preferably comprises, as an additive for improving engraving sensitivity, a high thermal conductivity material. A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer to a few nanometers are preferable. As the conductive polymer, a conjugated polymer is particularly preferable, and specific examples thereof include polyaniline and polythiophene.

It is preferable that the resin composition for laser engraving of the present invention does not contain nitrocellulose.

It is also preferable that the resin composition for laser engraving of the present invention comprises a co-sensitizer. In accordance with the use of a co-sensitizer, the sensitivity when photocuring the resin composition for laser engraving can be further improved.

Furthermore, it is preferable to add a small amount of a thermopolymerization inhibitor in order to prevent unwanted thermal polymerization of a polymerizable compound during production or storage of the resin composition.

For the purpose of coloring the resin composition for laser engraving, a colorant such as a dye or a pigment may be added. This enables properties such as visibility of an image area or suitability for an image densitometer to be improved.

Furthermore, in order to improve the physical properties of a cured film of the resin composition for laser engraving, a known additive such as a filler may be added.

### (Relief Printing Plate Precursor for Laser Engraving)

A first embodiment of the relief printing plate precursor for laser engraving in the present invention comprises a relief-forming layer formed from the resin composition for laser engraving of the present invention.

A second embodiment of the relief printing plate precursor for laser engraving in the present invention comprises a crosslinked relief-forming layer formed by crosslinking a relief-forming layer formed from the resin composition for laser engraving of the present invention.

In the present invention, the ‘relief printing plate precursor for laser engraving’ means both or one of a plate having a crosslinkable relief-forming layer formed from the resin composition for laser engraving in a state before being crosslinked and a plate in a state in which it is cured by light or heat.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is preferably carried out by means of heat and/or light. Furthermore, the crosslinking is not particularly limited as long as it is a reaction by which the resin composition is cured, and it is a concept that includes a structure crosslinked due to reactions between Component A's and between Component D's being optional component, between Component B's having polymerizable group, between Component B and Component A having polymerizable group and/or Component D.

The ‘relief printing plate’ is prepared by laser engraving a printing plate precursor having a crosslinked relief-forming layer.

Moreover, in the present invention, the ‘relief layer’ means a layer of the relief printing plate formed by engraving using a laser, that is, the crosslinked relief-forming layer after laser engraving.

A relief printing plate precursor for laser engraving in the present invention comprises a relief-forming layer formed from the resin composition for laser engraving of the present invention, which has the above-mentioned components. The (crosslinked) relief-forming layer is preferably provided above a support.

The (crosslinked) relief printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention and is a crosslinkable layer. With regard to the relief printing plate precursor for laser engraving of the present invention, it is preferable for it to further contain (Component D) a polymerizable compound and (Component E) a polymerization initiator in addition to a crosslinked structure formed from Component A and/or Component B having polymerizable group since one having a relief-forming layer to which further crosslinkable functionality is imparted is obtained.

As a mode in which a relief printing plate is prepared using the relief printing plate precursor for laser engraving, a mode in which a relief printing plate is prepared by crosslinking a relief-forming layer by means of light and/or heat to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an Example below.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers.

Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Relief Printing Plate Precursor for Laser Engraving)

Formation of a relief-forming layer in the relief printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for producing a relief printing plate precursor for laser engraving in the present invention is preferably a production process comprising a layer formation step of forming a relief-forming layer from the resin composition for laser engraving of the present invention and a crosslinking step of crosslinking the relief-forming layer by means of heat and/or light to thus obtain a relief printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the relief printing plate for laser engraving of the present invention preferably comprises a layer formation step of forming a relief-forming layer from the resin composition for laser engraving of the present invention.

Preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be produced by, for example, dissolving Component A, Component B, and as optional components a fragrance, Component C, Component F, an inorganic particles and/or a plasticizer in an appropriate solvent, and then dissolving Component D and Component E. Since it is necessary to remove most of the solvent component in a stage of producing a relief printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the (crosslinked) relief-forming layer in the relief printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

The shore A hardness of the (crosslinked) relief-forming layer in the relief printing plate precursor for laser engraving is preferably at least 50° but no greater than 90°.

### <Crosslinking Step>

The process for producing a relief printing plate precursor for laser engraving of the present invention is preferably a production process comprising a crosslinking step of crosslinking the relief-forming layer by means of heat and/or light to thus obtain a relief printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is usual to apply light to the entire surface of the relief-forming layer. Examples of the light (also called ‘actinic radiation’) include visible light, UV light, and an electron beam, but UV light is most commonly used. When the side where there is a substrate for fixing the relief-forming layer, such as a support for the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a vinyl chloride sheet on the relief-forming layer and evacuating.

When the relief-forming layer comprises a thermopolymerization initiator (it being possible for the above-mentioned photopolymerization initiator to function also as a thermopolymerization initiator), the relief-forming layer may be crosslinked by heating the relief printing plate precursor for laser engraving (step of crosslinking by heat). As heating means, there can be cited a method in which a printing plate precursor is heated in a hot air oven or an infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and a compound containing azo group. A representative vulcanizing agent may also be used for crosslinking. Thermal crosslinking may also be carried out by adding a thermally crosslinkable (heat-curable) resin such as for example an epoxy resin as a crosslinking component to a layer.

### (Relief Printing Plate and Process for Making Same)

The process for making a relief printing plate of the present invention comprises a layer formation step of forming a relief-forming layer from the resin composition for laser engraving of the present invention, a crosslinking step of crosslinking the relief-forming layer by means of heat and/or light to thus obtain a relief printing plate precursor having a crosslinked relief-forming layer, and an engraving step of laser-engraving the relief printing plate precursor having the crosslinked relief-forming layer.

The relief printing plate of the present invention is a relief printing plate having a relief layer obtained by crosslinking and laser-engraving a layer formed from the resin composition for laser engraving of the present invention, and is preferably a relief printing plate made by the process for making a relief printing plate of the present invention.

The relief printing plate of the present invention can be preferably used for printing an aqueous ink.

The layer formation step and the crosslinking step in the process for making a relief printing plate of the present invention mean the same as the layer formation step and the crosslinking step in the above-mentioned process for producing a relief printing plate precursor for laser engraving, and preferred ranges are also the same.

### <Engraving Step>

The process for making a relief printing plate of the present invention comprises an engraving step of laser-engraving the relief printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a relief printing plate employing the relief printing plate precursor of the present invention, is described in detail in JP-A-2009-172658 and JP-A-2009-214334.

The process for making a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a processor for a photosensitive resin relief printing plate precursor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2, particularly preferably no greater than 13, and most preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

The betaine compound is preferably a compound represented by Formula (1) below and/or a compound represented by Formula (2) below.

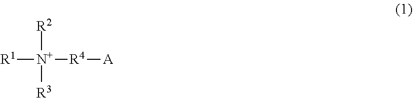

(In Formula (1), R¹ to R³ independently denote a monovalent organic group, R⁴ denotes a single bond or a divalent linking group, A denotes PO(OR⁵)O⁻, OPO(OR⁵)O⁻, O⁻, COO⁻, or SO₃⁻, R⁵ denotes a hydrogen atom or a monovalent organic group, and two or more groups of R¹ to R³ may be bonded to each other to form a ring.)

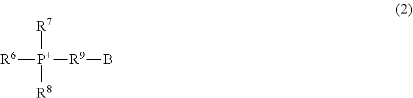

(In Formula (2), R⁶ to R⁸ independently denote a monovalent organic group, R⁹ denotes a single bond or a divalent linking group, B denotes PO(OR¹⁹)O⁻, OPO(OR¹⁰)O⁻, O⁻, COO⁻, or SO₃⁻, R¹⁰ denotes a hydrogen atom or a monovalent organic group, and two or more groups of R⁶ to R⁸ may be bonded to each other to form a ring.)

The compound represented by Formula (1) above or the compound represented by Formula (2) above is preferably a carboxybetaine compound, a sulfobetaine compound, a phosphobetaine compound, an amine oxide compound, or a phosphine oxide compound. In the present invention, the structures of N═O of an amine oxide compound and P═O of a phosphine oxide compound are considered to be N⁺—O⁻ and P⁺—O⁻ respectively.

R¹ to R³ in Formula (1) above independently denote a monovalent organic group. Two or more groups of R¹ to R³ may be bonded to each other to form a ring, but it is preferable that no ring is formed.

The monovalent organic group denoted by R¹ to R³ is not particularly limited, but is preferably an alkyl group, a hydroxy group-containing alkyl group, an alkyl group having an amide bond in an alkyl chain, or an alkyl group having an ether bond in an alkyl chain, and is more preferably an alkyl group, a hydroxy group-containing alkyl group, or an alkyl group having an amide bond in an alkyl chain.

Furthermore, the alkyl group as the monovalent organic group may have a straight chain, branched, or cyclic structure.

Moreover, it is particularly preferable that two of R¹ to R³ are methyl groups, that is, a compound represented by Formula (1) has an N,N-dimethyl structure. When it has the above-mentioned structure, particularly good rinsing properties are exhibited.

R⁴ in Formula (1) above denotes a single bond or a divalent linking group, and is a single bond when a compound represented by Formula (1) is an amine oxide compound.

The divalent linking group denoted by R⁴ is not particularly limited, and is preferably an alkylene group or a hydroxy group-containing alkylene group, more preferably an alkylene group having 1 to 8 carbon atoms or a hydroxy group-containing alkylene group having 1 to 8 carbon atoms, and yet more preferably an alkylene group having 1 to 3 carbon atoms or a hydroxy group-containing-alkylene group having 1 to 3 carbon atoms.

A in Formula (1) above denotes PO(OR⁵)O⁻, OPO(OR⁵)O⁻, O⁻, COO⁻, or SO₃⁻, and is preferably O⁻, COO⁻, or SO₃⁻, and more preferably COO⁻.

When A is O⁻, R⁴ is preferably a single bond.

R⁵ in PO(OR⁵)O⁻ and OPO(OR⁵)O⁻ denotes a hydrogen atom or a monovalent organic group, and is preferably a hydrogen atom or an alkyl group having one or more unsaturated fatty acid ester structures.

Furthermore, R⁴ is preferably a group that does not have PO(OR⁵)O⁻, OPO(OR⁵)O⁻, O⁻, COO⁻, or SO₃⁻.

R⁶ to R⁸ in Formula (2) above independently denote a monovalent organic group. Two or more groups of R⁶ to R⁸ may be bonded to each other to form a ring, but it is preferable that no ring is formed.

The monovalent organic group denoted by R⁶ to R⁸ is not particularly limited, but is preferably an alkyl group, an alkenyl group, an aryl group, or a hydroxy group, and more preferably an alkenyl group, an aryl group, or a hydroxy group.

Furthermore, the alkyl group as the monovalent organic group may have a straight chain, branched, or cyclic structure.

It is particularly preferable that two of R⁶ to R⁸ are aryl groups.

R⁹ in Formula (2) above denotes a single bond or a divalent linking group, and is a single bond when a compound represented by Formula (2) is a phosphine oxide compound.

The divalent linking group denoted by R⁹ is not particularly limited, but is preferably an alkylene group or a hydroxy group-containing alkylene group, more preferably an alkylene group having 1 to 8 carbon atoms or a hydroxy group-containing alkylene group having 1 to 8 carbon atoms, and yet more preferably an alkylene group having 1 to 3 carbon atoms or a hydroxy group-containing alkylene group having 1 to 3 carbon atoms.

B in Formula (2) above denotes PO(OR¹⁰)O⁻, OPO(OR¹⁰)O⁻, O⁻, COO⁻, or SO₃⁻, and is preferably O⁻.

When B⁻ is O⁻, R⁹ is preferably a single bond.

R¹⁰ in PO(OR¹⁰)O⁻ and OPO(OR¹⁰)O⁻ denotes a hydrogen atom or a monovalent organic group, and is preferably a hydrogen atom or an alkyl group having one or more unsaturated fatty acid ester structures.

Furthermore, R⁹ is preferably a group that does not have PO(OR¹⁰)O⁻, OPO(OR¹⁶)O⁻, O⁻, COO⁻, or SO₃⁻.

A compound represented by Formula (1) is preferably a compound represented by Formula (3) below.

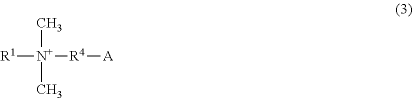

(In Formula (3), R¹ denotes a monovalent organic group, R⁴ denotes a single bond or a divalent linking group, A denotes PO(OR⁵)O⁻, OPO(OR⁵)O⁻, O⁻, COO⁻, or SO₃⁻, and R⁵ denotes a hydrogen atom or a monovalent organic group.)

R¹, A, and R⁵ in Formula (3) have the same meanings as R¹, A, and R⁵ in Formula (1) above, and preferred ranges are also the same.

A compound represented by Formula (2) is preferably a compound represented by Formula (4) below.

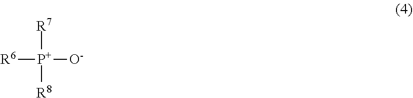

(In Formula (4), R⁶ to R⁸ independently denote an alkyl group, an alkenyl group, an aryl group, or a hydroxy group. In addition, not all of R⁶ to R⁸ are the same groups.)

R⁶ to R⁸ in Formula (4) above independently denote an alkyl group, an alkenyl group, an aryl group, or a hydroxy group, and are preferably an alkenyl group, an aryl group, or a hydroxy group.

Specific examples of the compound represented by Formula (1) and the compound represented by Formula (2) include the compounds below.

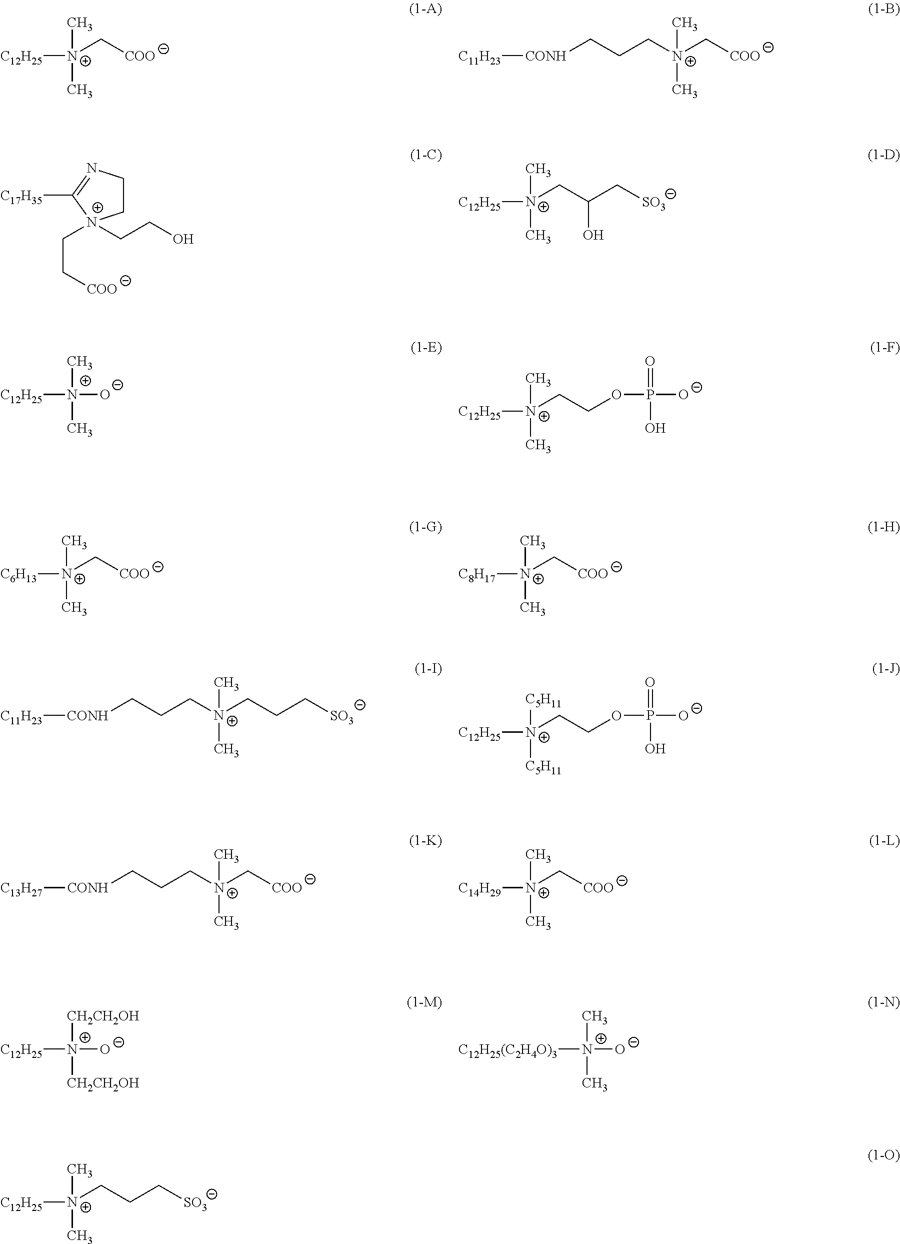

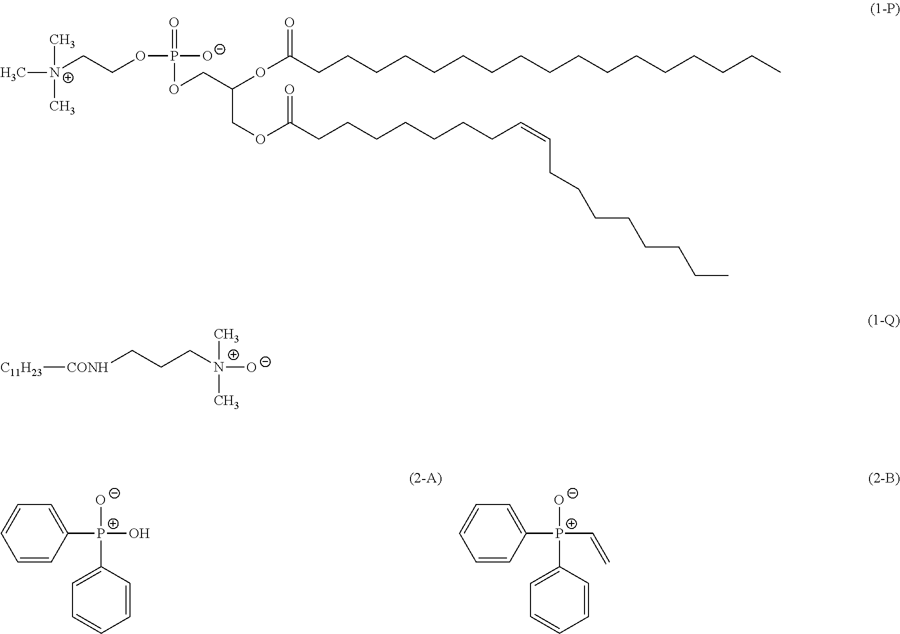

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 weight % relative to the total weight of the rinsing liquid, and more preferably 0.05 to 10 weight %.

The relief printing plate of the present invention having a relief layer on the surface of any substrate such as a support etc. may be produced as described above.

From the viewpoint of satisfying suitability for various aspects of printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the relief printing plate is preferably at least 50° but no greater than 90°.

When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The relief printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The relief printing plate of the present invention has excellent rinsing properties, there is no engraving residue, since a relief layer obtained has excellent elasticity aqueous ink transfer properties and printing durability are excellent, and printing can be carried out for a long period of time without plastic deformation of the relief layer or degradation of printing durability.

In accordance with the present invention, there can be provided a resin composition for laser engraving that can give a relief printing plate having excellent film breaking strength and aqueous ink transfer properties and that has excellent rinsing properties for engraving residue generated when laser-engraving a printing plate and excellent engraving sensitivity in laser engraving, a relief printing plate precursor employing the resin composition for laser engraving, a process for making a relief printing plate employing same, and a relief printing plate obtained thereby.

### EXAMPLES

The present invention is explained in further detail below by reference to Examples, but the present invention should not be construed as being limited to these Examples. The number-average molecular weight of Examples was measured by GPC unless otherwise specified.

### Synthetic Example 1

### Synthesis of Polyurethane PU-1

A separable flask equipped with a thermometer, a stirrer, and a reflux condenser was charged with 447.24 parts by weight of a polycarbonate diol (‘PCDL (registered trademark) L4672’, Asahi Chemical Industry Co., Ltd.: number-average molecular weight 1,990, OH value 56.4) and 30.83 parts by weight of tolylene diisocyanate, and a reaction was carried out while heating at 80° C. for about 3 hours. Subsequently, 14.83 parts by weight of 2-methacryloyloxy isocyanate (‘MOI’, Showa Denko K.K.) was added, and a reaction was further carried out for about 3 hours, thus giving Polyurethane PU-1 having a number-average molecular weight of about 10,000 with a methacrylic group at a main chain terminus (about 2 per molecule on average of polymerizable unsaturated groups in the molecule).

Polyurethane PU-1 was in a syrup form at 20° C. and became fluid under an external force, but did not recover to the original shape after the external force was removed.

### Synthetic Example 2

### Synthesis of Polyurethane PU-2

A separable flask equipped with a thermometer, a stirrer, and a reflux condenser was charged with 759.5 parts by weight of a hydrogenated polybutadienediol (‘GI-3000’, Nippon Soda Co., Ltd.: number-average molecular weight 3,940) and 46.21 parts by weight of tolylene diisocyanate, and a reaction was carried out while heating at 80° C. for about 4 hours. Subsequently, 27.24 parts by weight of 2-hydroxypropyl methacrylate was added, and a reaction was further carried out for about 3 hours, thus giving Polyurethane PU-2 having a number-average molecular weight of about 10,000 with a methacrylic group at a main chain terminus (about 2 per molecule on average of polymerizable unsaturated groups in the molecule).

Polyurethane PU-2 was in a syrup form at 20° C. and became fluid under an external force, but did not recover to the original shape after the external force was removed.

### Synthetic Example 3

### Synthesis of Polyurethane PU-3

A separable flask equipped with a thermometer, a stirrer, and a reflux condenser was charged with 420.2 parts by weight of a polyester diol (‘P-3010’, Kuraray Co., Ltd.; number-average molecular weight 3,000), 420.2 parts by weight of a polyether diol (‘PL’, Sanyo Chemical Industries, Ltd.; number-average molecular weight 2,500), and 63.22 parts by weight of tolylene diisocyanate, and a reaction was carried out while heating at 80° C. for about 4 hours. Subsequently, 42.07 parts by weight of 2-hydroxypropyl methacrylate was added, and a reaction was further carried out for about 3 hours, thus giving Polyurethane PU-3 having a number-average molecular weight of about 18,000 with a methacrylic group at a main chain terminus (about 2 per molecule on average of polymerizable unsaturated groups in the molecule).

Polyurethane PU-3 was in a syrup form at 20° C. and became fluid under an external force, but did not recover to the original shape after the external force was removed.

### Synthetic Example 4

### Synthesis of Polyurethane PU-4

A separable flask equipped with a thermometer, a stirrer, and a reflux condenser was charged with 400 parts by weight of a polycarbonate diol (‘PCDL (registered trademark) L4672’, Asahi Chemical Industry Co., Ltd.: number-average molecular weight 1,990, OH value 56.4), 32 parts by weight of Blemmer GLM (glycerol monomethacrylate; NOF Corporation), and 30.83 parts by weight of tolylene diisocyanate, and a reaction was carried out while heating at 80° C. for about 3 hours. Subsequently, 10.5 parts by weight of n-butyl isocyanate (Wako Pure Chemical. Industries, Ltd.) was added, and a reaction was further carried out for about 3 hours, thus giving Polyurethane PU-4 having a number-average molecular weight of about 80,000 with a methacrylic group as a side chain (methacrylic group content: about 1 meq/g).

### Synthetic Example 5

### Synthesis of Polyurethane PU-5

A separable flask equipped with a thermometer, a stirrer, and a reflux condenser was charged with 50 parts by weight of polypropylene glycol (Wako Pure Chemical Industries, Ltd.: number-average molecular weight 2,000), 120 parts by weight of 1,4-butanediol (Wako Pure Chemical Industries, Ltd.), and 30.83 parts by weight of tolylene diisocyanate, and a reaction was carried out while heating at 80° C. for about 3 hours. Subsequently, 10.25 parts by weight of n-butyl isocyanate (Wako Pure Chemical Industries, Ltd.) was added, and a reaction was further carried out for about 3 hours, thus giving Polyurethane PU-5 having a number-average molecular weight of about 74,000 without any polymerizable unsaturated group in the molecule.

### Synthetic Example 6

### Synthesis of Polyurethane PU-6

A separable flask equipped with a thermometer, a stirrer, and a reflux condenser was charged with 400 parts by weight of a polycarbonate diol (‘PCDL (registered trademark) L4672’, Asahi Chemical Industry Co., Ltd.: number-average molecular weight 1,990, OH value 56.4), 38 parts by weight of dimethylolpropionic acid (Tokyo Chemical Industry Co., Ltd.), and 30.83 parts by weight of tolylene diisocyanate, and a reaction was carried out while heating at 80° C. for about 3 hours. Subsequently, 14.83 parts by weight of 2-methacryloyloxy isocyanate (‘MOI’, Showa Denko K.K.) was added, and a reaction was further carried out for about 3 hours, thus giving Polyurethane PU-6 having a number-average molecular weight of about 35,000 with a carboxy group in a side chain.

### Synthetic Example 7

### Synthesis of Polyurethane PU-7

A separable flask equipped with a thermometer, a stirrer, and a reflux condenser was charged with 759.5 parts by weight of a hydrogenated polybutadienediol (‘GI-3000’, Nippon Soda Co., Ltd.: number-average molecular weight 3,940), 3 parts by weight of trimethylolpropane (Wako Pure Chemical Industries, Ltd.), and 46.21 parts by weight of tolylene diisocyanate, and a reaction was carried out while heating at 80° C. for about 4 hours. Subsequently, 27.24 parts by weight of 2-hydroxypropyl methacrylate was added, and a reaction was further carried out for about 3 hours, thus giving Polyurethane PU-7 having a number-average molecular weight of about 125,000 with a hydroxy group in a side chain.

### Example 1

### 1. Preparation of Resin Composition for Laser Engraving

A liquid resin composition was obtained by mixing the components below at 70° C.
Component A KBE-846 (Shin-Etsu Chemical Co., Ltd.): 20 parts by weight Component B Polyurethane PU-1 obtained in Synthetic Example 1: 70 parts by weight
Component C 1,8-diazabicyclo[5.4.0]undec-7-ene (DBU) (Wako Pure Chemical Industries, Ltd.): 0.8 parts by weight
Component D phenoxyethyl methacrylate (‘Light-Ester (registered trademark) PO’, Kyoeisha Chemical Co., Ltd.: molecular weight 206): 20 parts by weight, and polypropylene glycol monomethacrylate (‘PPM’, NOF Corporation: molecular weight 400): 10 parts by weight
Component E t-butylperoxy 2-ethylhexyl carbonate (‘Perbutyl (registered trademark) E’, NOF Corporation): 1 part by weight
Component F Ketjen Black EC600JD (carbon black, Lion Corporation): 2 parts by weight
Inorganic Particles porous fine silica powder (‘Sylosphere (registered trademark) C-1504’, Fuji Silysia Chemical Ltd.: number-average particle size 4.5 ρm, specific surface area 520 m²/g, average pore diameter 12 nm, pore volume 1.5 mL/g, loss on ignition 2.5 weight %, oil absorption 290 mL/100 g): 5 parts by weight

As a stabilizer, 0.5 parts by weight of 2,6-di-t-butylacetophenone (‘IONOL (registered trademark) CP’, Japan Chemtech Ltd.) was added to the resin composition obtained above, and mixing was further carried out at 70° C., thus giving resin composition 1 for laser engraving.

### 2. Preparation of Relief Printing Plate Precursor for Laser Engraving

A spacer (frame) having a predetermined thickness was placed on a PET substrate, and resin composition 1 for laser engraving obtained above was cast gently so that it did not overflow from the spacer (frame) and dried in an oven at 70° C. for 3 hours to provide a relief-forming layer having a thickness of about 1 mm, thus preparing relief printing plate precursor 1 for laser engraving.

### 3. Making Relief Printing Plate

The relief-forming layer of the plate precursor obtained was heated at 80° C. for 3 hours and further at 100° C. for 3 hours, thus thermally crosslinking the relief-forming layer.

The crosslinked relief-forming layer was engraved using the two types of laser below.

### (Engraving Using CO₂)

As a carbon dioxide laser (CO₂ laser) engraving machine, for engraving by irradiation with a laser, an ML-9100 series high quality CO₂ laser marker (Keyence) was used. After a protection film was peeled off from the printing plate precursor 1 for laser engraving, a 1 cm square solid printed part was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI.

The thickness of the relief layer of the relief printing plate was approximately 1 mm.

Furthermore, when the Shore A hardness of the relief layer was measured by the above-mentioned measurement method, it was found to be 75°. Measurement of Shore A hardness was carried out in the same manner for the Examples and Comparative Examples described below.

### Examples 2 to 27 and Comparative Examples 1 to 4

Resin compositions for laser engraving, relief printing plate precursors for laser engraving, and relief printing plates were obtained for Examples 2 to 27 and Comparative Examples 1 to 4 by the same method as in Example 1 except that (A) to (F) and the inorganic particles used in Example 1 were changed to those shown in Table 1.

In Example 19, the resin composition for laser engraving obtained in Example 1 was made into a sleeve as follows, thus giving a cylindrical printing plate precursor and a cylindrical printing plate.

First, the resin composition for laser engraving obtained in Example 1 was vigorously stirred in nitrogen gas, thus forming fine bubbles in the resin composition. Subsequently, a polyethylene fiber-reinforced plastic sleeve (AKL, Germany) having an inner diameter of 200 nm and a thickness of 0.45 mm was fitted around an air cylinder with a diameter of 200 mm, and the resin composition was applied at a thickness of 0.5 mm using a doctor blade while rotating the air cylinder. Subsequently, while rotating the air cylinder, heating was carried out in a thermostatic chamber at 150° C. under an air atmosphere for 30 minutes so as to cure the resin composition, thus giving a cushion layer comprising a resin cured material.

Subsequently, the cushion layer thus formed was coated using a doctor blade with the resin composition for laser engraving obtained in Example 1 at a thickness of 1.4 mm while rotating the air cylinder. Subsequently, while rotating the air cylinder, heating was carried out in a thermostatic chamber at 150° C. under an air atmosphere for 30 minutes, thus giving a thermally curable resin-cured material having a thickness of about 1.4 mm. Subsequently, the resin cured material surface was ground by means of a grinding wheel (carborundum) using a grinding/polishing machine (Techno Giken Co., Ltd., Japan), and polished and finished using a #1000 lapping film, thus giving a cylindrical printing plate precursor having a resin-cured material layer via the cushion layer.

A pattern was formed on the surface of the cylindrical printing plate precursor thus obtained using a laser engraving machine, thus giving a cylindrical printing plate.

Furthermore, Examples 20 to 22 employed photocuring (photocrosslinking) instead of thermal curing (thermal crosslinking) as a curing method. Photocuring was carried out as follows.

The photosensitive resin composition obtained in each of Examples 20 to 22 was formed into a 3.0 mm thick sheet shape on a 100 μm thick PET film (Toray), and exposed to light in the atmosphere using exposure equipment (‘ALF model 213E’, Asahi Chemical Industry Co., Ltd.) under conditions of 4000 mJ. The light used for exposure was light from a UV fluorescent lamp (‘Chemical Lamp’, Toshiba Corporation: center wavelength: 370 nm) and light from a germicidal lamp (‘Germicidal Lamp’, Toshiba Corporation: center wavelength: 253 nm).

TABLE 1

| | Composition | | | | | | | |
|---|---|---|---|---|---|---|---|---|
| | | | | | | | Inorganic | |
| | Comp. A | Comp. B | Comp. C | Comp. D | Comp. E | Comp. F | particles | Curing method |
| Example 1 | A-1 | PU-1 | C-1 | D-1, D-2 | E-1 | F-1 | P | Thermal crosslinking |
| Example 2 | A-1 | PU-2 | C-1 | D-1, D-2 | E-1 | F-1 | P | Thermal crosslinking |
| Example 3 | A-1 | PU-3 | C-1 | D-1, D-2 | E-1 | F-1 | P | Thermal crosslinking |
| Example 4 | A-1 | PU-4 | C-1 | D-1, D-2 | E-1 | F-1 | P | Thermal crosslinking |
| Example 5 | A-1 | PU-5 | C-1 | D-1, D-2 | E-1 | F-1 | P | Thermal crosslinking |
| Example 6 | A-1 | PU-6 | C-1 | D-1, D-2 | E-1 | F-1 | P | Thermal crosslinking |
| Example 7 | A-1 | PU-7 | C-1 | D-1, D-2 | E-1 | F-1 | P | Thermal crosslinking |
| Example 8 | A-2 | PU-1 | C-1 | D-1, D-2 | E-1 | F-1 | P | Thermal crosslinking |
| Example 9 | A-3 | PU-1 | C-1 | D-1, D-2 | E-1 | F-1 | P | Thermal crosslinking |
| Example 10 | A-4 | PU-1 | C-1 | D-1, D-2 | E-1 | F-1 | P | Thermal crosslinking |
| Example 11 | A-5 | PU-1 | C-1 | D-1, D-2 | E-1 | F-1 | P | Thermal crosslinking |
| Example 12 | A-6 | PU-1 | C-1 | D-1, D-2 | E-1 | F-1 | P | Thermal crosslinking |
| Example 13 | A-7 | PU-1 | C-1 | D-1, D-2 | E-1 | F-1 | P | Thermal crosslinking |
| Example 14 | A-8 | PU-1 | C-1 | D-1, D-2 | E-1 | F-1 | P | Thermal crosslinking |
| Example 15 | A-9 | PU-1 | C-1 | D-1, D-2 | E-1 | F-1 | P | Thermal crosslinking |
| Example 16 | A-10 | PU-1 | C-1 | D-1, D-2 | E-1 | F-1 | P | Thermal crosslinking |
| Example 17 | A-1 | PU-2 | C-1 | D-1, D-2 | E-1 | F-1 | — | Thermal crosslinking |
| Example 18 | A-1 | PU-2 | C-1 | D-1, D-2 | E-1 | F-1 | NP | Thermal crosslinking |
| Example 19 | A-1 | PU-2 | C-1 | D-1, D-2 | E-1 | F-1 | P | Thermal crosslinking |
| Example 20 | A-1 | PU-1 | C-1 | D-1, D-2 | E-2 | — | P | Photocrosslinking |
| Example 21 | A-1 | PU-2 | C-1 | D-1, D-2 | E-2 | — | P | Photocrosslinking |
| Example 22 | A-1 | PU-3 | C-1 | D-1, D-2 | E-2 | — | P | Photocrosslinking |
| Example 23 | A-1 | PU-1 | C-1 | — | — | — | P | Thermal crosslinking |
| Example 24 | A-1 | PU-1 | — | — | — | — | P | Thermal crosslinking |
| Example 25 | A-1 | PU-1 | C-2 | — | — | — | P | Thermal crosslinking |
| Example 26 | A-1 | PU-5 | — | — | — | — | P | Thermal crosslinking |
| Example 27 | A-7 | PU-5 | — | — | — | — | P | Thermal crosslinking |
| Comp. Ex. 1 | — | PU-1 | C-1 | D-1, D-2 | E-1 | F-1 | P | Thermal crosslinking |
| Comp. Ex. 2 | — | PU-2 | C-1 | D-1, D-2 | E-1 | F-1 | P | Thermal crosslinking |
| Comp. Ex. 3 | — | PU-3 | C-1 | D-1, D-2 | E-1 | F-1 | P | Thermal crosslinking |
| Comp. Ex. 4 | A-1 | NR | C-1 | D-1. D-2 | E-1 | F-1 | P | Thermal crosslinking |

| | Evaluation results | | | | | |
|---|---|---|---|---|---|---|
| | | | Rinsing properties | | Breaking | Aqueous ink |
| | Engraving depth (μm) | | | Alkaline | strength | transfer |
| | CO₂ laser | FC-LD | Water | washing liquid | (N/cm) | properties |
| Example 1 | 310 | 393 | Fair | Good | 20 | Good |
| Example 2 | 320 | 405 | Fair | Good | 20 | Good |
| Example 3 | 320 | 405 | Fair | Good | 20 | Good |
| Example 4 | 320 | 405 | Fair | Good | 20 | Good |
| Example 5 | 300 | 360 | Fair | Good | 20 | Good |
| Example 6 | 290 | 380 | Good to Fair | Good | 24 | Good |
| Example 7 | 280 | 370 | Fair | Good | 21 | Good |
| Example 8 | 290 | 367 | Fair | Good | 23 | Good |
| Example 9 | 310 | 393 | Fair | Good | 17 | Good |
| Example 10 | 270 | 360 | Fair | Fair | 9 | Good |
| Example 11 | 300 | 380 | Fair | Good to Fair | 10 | Good |
| Example 12 | 300 | 380 | Fair | Good to Fair | 11 | Good |
| Example 13 | 300 | 380 | Fair | Good to Fair | 10 | Good |
| Example 14 | 300 | 380 | Fair | Good to Fair | 10 | Good |
| Example 15 | 280 | 355 | Fair | Good | 18 | Good |
| Example 16 | 280 | 355 | Fair | Good | 17 | Good |
| Example 17 | 280 | 355 | Fair to Poor | Good to Fair | 10 | Good to Fair |
| Example 18 | 320 | 405 | Fair | Good | 17 | Good |
| Example 19 | 320 | 405 | Fair | Good | 17 | Good |
| Example 20 | 320 | 0 | Fair | Fair | 9 | Good |
| Example 21 | 320 | 0 | Fair | Fair | 9 | Good |
| Example 22 | 320 | 0 | Fair | Fair | 9 | Good |
| Example 23 | 320 | 400 | Fair | Good | 16 | Good |
| Example 24 | 320 | 400 | Fair | Good | 11 | Fair |
| Example 25 | 320 | 400 | Fair | Good | 14 | Good to Fair |
| Example 26 | 320 | 360 | Fair | Good | 8 | Good to Fair |
| Example 27 | 320 | 360 | Fair | Good | 9 | Good to Fair |
| Comp. Ex. 1 | 280 | 340 | Poor | Poor | 4 | Fair |
| Comp. Ex. 2 | 290 | 330 | Poor | Fair | 3 | Fair |
| Comp. Ex. 3 | 270 | 320 | Poor | Fair | 5 | Poor |
| Comp. Ex. 4 | 270 | 320 | Fair to Poor | Good to Fair | 5 | Poor |

A-2: X-12-965 (tris(3-trimethoxysilylpropyl) isocyanurate, Shin-Etsu Chemical Co., Ltd.)
A-3: KBE-3026 (bis(triethoxysilyl)ethane, Shin-Etsu Chemical Co., Ltd.)
A-4: KBM-503 (3-methacryloxypropyltrimethoxysilane, Shin-Etsu Chemical Co., Ltd.)
A-5: KBE-603 (N-2-(aminoethyl)-3-aminopropyltriethoxysilane, Shin-Etsu Chemical Co., Ltd.)
A-6: KBE-403 (3-glycidoxypropyltriethoxysilane, Shin-Etsu Chemical Co., Ltd.)
A-7: KBE-803 (3-mercaptopropyltriethoxysilane, Shin-Etsu Chemical Co., Ltd.)
A-8: KBM-3063 (hexyltrimethoxysilane, Shin-Etsu Chemical Co., Ltd.)
A-9: SR 2402 (methylmethoxysiloxane oligomer, structure undisclosed, Dow Corning Toray)
A-10: Z-6173 (alkylalkoxysiloxane oligomer, structure undisclosed, Dow Corning Toray)
<Component B: binder polymer>
PU-1 to PU-7: Polyurethanes PU-1 to PU-7 obtained in Synthetic Examples 1 to 7 respectively
NR: natural rubber (Nomura Trading Co., Ltd.)
<Component C: catalyst>
C-1: 1,8-diazabicyclo[5.4.0]undec-7-ene (DBU) (Wako Pure Chemical Industries, Ltd.)
C-2: phosphoric acid (Wako Pure Chemical Industries, Ltd.)
<Component D: polymerizable compound>
D-1: phenoxyethyl methacrylate (‘Light-Ester (registered trademark) PO’, Kyoeisha Chemical Co., Ltd.: molecular weight 206)
D-2: polypropylene glycol monomethacrylate (‘PPM’, NOF Corporation: molecular weight 400)
<Component E: polymerization initiator>
E-1: t-butylperoxy 2-ethylhexyl carbonate (‘Perbutyl (registered trademark) E’, NOF Corporation)
E-2: Irgacure 184 (Ciba-Geigy Ltd.) (1-hydroxycyclohexyl phenyl ketone)
<Component F: photothermal conversion agent>
F-1: Ketjen Black EC600JD (carbon black, Lion Corporation)
<Inorganic particles>
P (porous particles): porous fine silica powder (‘Sylosphere (registered trademark) C-1504’, Fuji Silysia Chemical Ltd.: number-average particle size 4.5 μm, specific surface area 520 m²/g, average pore diameter 12 nm, pore volume 1.5 mL/g, loss on ignition 2.5 weight %, oil absorption 290 mL/100 g)
NP (nonporous particles): AEROSIL 200CF (Nippon Aerosil Co., Ltd.)

### 4. Evaluation of Relief Printing Plate

Evaluation of relief printing plate performance was carried out for the items below, and the results are summarized in Table 1.

### (4-1) Engraving Depth

The ‘engraving depth’ of a relief layer obtained by laser engraving a relief-forming layer of a relief printing plate precursor of each of the Examples and Comparative Examples was measured as follows. The ‘engraving depth’ referred to here means the difference between an engraved position (height) and an unengraved position (height) when a cross-section of the relief layer was examined. The ‘engraving depth’ in the present Examples was measured by examining a cross-section of a relief layer using a VK9510 ultradepth color 3D profile measurement microscope (Keyence). A large engraving depth means a high engraving sensitivity. The results are given in Table 1 for each of the types of laser used for engraving.

### (4-2) Rinsing Properties

A rinsing liquid was prepared by mixing water, a 10 wt % aqueous solution of sodium hydroxide, and betaine compound (1-B) below so that the pH was 12 and the content of betaine compound (1-B) was 1 weight % of the total rinsing liquid.

The rinsing liquid thus prepared was dropped (about 100 mL/m²) by means of a pipette onto a plate material engraved by the above-mentioned method so that the plate surface became uniformly wet, was allowed to stand for 1 min, and rubbed using a toothbrush (Clinica Toothbrush Flat, Lion Corporation) 20 times (30 sec) in parallel to the plate with a load of 200 gf. Subsequently, the plate face was washed with running water, moisture of the plate face was removed, and it was naturally dried for approximately 1 hour.

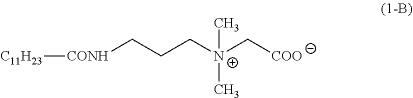

### (Evaluation)

### <Residue Removability>

Unremoved residue on the plate was evaluated by examining the rinsed plate surface using a 100x magnification microscope (Keyence). Evaluation criteria were as follows.
Poor: residue adhering to the entire plate face.
Fair to Poor: slight residue remaining on convex parts of plate image, and residue remaining in bottom parts of image (concave parts).
Fair: slight residue remaining on convex parts of plate image, and slight residue remaining in bottom parts of image (concave parts).
Good to Fair: slight residue remaining in bottom parts of image (concave parts).
Good: no residue at all remaining on plate.

### (4-3) Film Breaking Strength

A cured film (relief layer) obtained by curing a resin composition for laser engraving in the Examples and Comparative Examples was subjected to measurement of breaking strength as follows.

As a tensile tester, a Shimadzu AGSH5000 manufactured by Shimadzu Corporation was used, and a test sample was measured by forming it into a dumbbell shape (measured inputting an average width of 2.25 cm) in accordance with JIS. Measurement conditions were a temperature of about 21° C., a humidity of 60%, and a stretching speed of 2 mm/min.

### (4-4) Aqueous Ink Transfer Properties

A relief printing plate that had been obtained was set in a printer (Model ITM-4, Iyo Kikai Seisakujo Co., Ltd.), printing was continued using the aqueous ink Aqua SPZ16 rouge (Toyo Ink Mfg. Co., Ltd.) as an ink without dilution and Full Color Form M 70 (Nippon Paper Industries Co., Ltd., thickness 100 μm) as printing paper, and 1% to 10% highlights were checked for the printed material. The degree of ink attachment of a solid printed part on the printed material at a paper length (meters) of 500 m and 1,000 m from the start of printing was compared by visual inspection.

One that was uniform without unevenness in density was evaluated as Good, one with unevenness was evaluated as Poor, one with slight unevenness was evaluated as Good to Fair, and one with unevenness but no problem in actual application was evaluated as Fair.

As shown in Table 1, the relief printing plates of the Examples prepared using resin compositions for laser engraving comprising (Component A) a compound having a hydrolyzable silyl group and/or a silanol group and a polyurethane as (Component B) a binder polymer have excellent rinsing properties and high productivity during plate making compared with the relief printing plates of the Comparative Examples. Furthermore, since the breaking strength of the relief layer and the ink transfer properties are good, excellent printing performance can be exhibited for a long period of time and, moreover, the engraving depth is large, the engraving sensitivity is good. On the other hand, the relief layer of the Comparative Examples did not have sufficient breaking strength, and the rinsing properties and the aqueous ink transfer properties were all poor.

It can be seen that, as Component A, compound (A-1) having a sulfide group in the molecule, compound (A-2) having a urethane bond in the molecule, compound (A-3) having two hydrolyzable silyl groups and/or silanol groups in the molecule (difunctional silyl compound), and a siloxane oligomer (A-9, A-10) had good rinsing properties.

It can also be seen that, when the same relief printing plate precursors were used, engraving depth could be further improved by the use of plate making equipment comprising a fiber-coupled semiconductor laser and employing an FC-LD as a light source. In addition, the engraving depth by FC-LD of 0 μm in Examples 20 to 22 was due to the resin compositions containing no component that absorbed the laser light.

1. A process for making a relief printing plate, comprising:
a layer formation step of forming a relief-forming layer from a resin composition comprising (Component A) a compound having a hydrolyzable silyl group and/or a silanol group and a polyurethane as (Component B) a binder polymer;
a crosslinking step of crosslinking the relief-forming layer by heat and/or light to thus obtain a relief printing plate precursor having a crosslinked relief-forming layer; and
an engraving step of laser-engraving the relief printing plate precursor having a crosslinked relief-forming layer to thus form a relief layer.

2. The process for making a relief printing plate according to claim 1, wherein Component A above is a compound having two or more hydrolyzable silyl groups and silanol groups.

3. The process for making a relief printing plate according to claim 1, wherein the hydrolyzable silyl group of Component A above is a residue in which at least one of an alkoxy group and a halogen atom is directly bonded to the Si atom.

4. The process for making a relief printing plate according to claim 1, wherein Component A above has a group represented by Formula (1) below 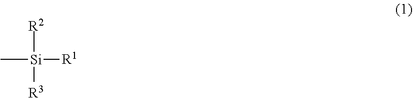
wherein at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group, and the rest of R¹ to R³ independently denote a hydrogen atom, a halogen atom, or a monovalent organic substituent.

5. The process for making a relief printing plate according to claim 1, wherein Component A above is a compound represented by Formula (A-1) or Formula (A-2) below 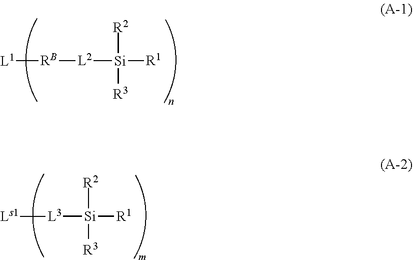
wherein R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent; in addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.

6. The process for making a relief printing plate according to claim 1, wherein Component B above is in a liquid state at 20° C.

7. The process for making a relief printing plate according to claim 1, wherein Component B above has an ethylenically unsaturated group at a polymer main chain terminus and/or in a side chain.

8. The process for making a relief printing plate according to claim 1, wherein Component B above has a temperature at which the weight falls to one half of 150° C. to 450° C.

9. The process for making a relief printing plate according to claim 1, wherein the resin composition further comprises (Component C) a catalyst for promoting a decomposition reaction and/or condensation reaction of Component A above.

10. The process for making a relief printing plate according to claim 9, wherein Component C above is (Component C-1) an acidic or basic catalyst or (Component C-2) a metal complex catalyst.

11. The process for making a relief printing plate according to claim 1, wherein the resin composition further comprises (Component D) a polymerizable compound.

12. The process for making a relief printing plate according to claim 1, wherein the resin composition further comprises (Component E) a polymerization initiator.

13. The process for making a relief printing plate according to claim 1, wherein the resin composition further comprises (Component F) a photothermal conversion agent that can absorb light having a wavelength of 700 to 1,300 nm.

14. The process for making a relief printing plate according to claim 1, wherein the resin composition further comprises inorganic particles.

15. The process for making a relief printing plate according to claim 1, wherein the relief printing plate precursor comprises a relief-forming layer comprising the resin composition and having a crosslinked structure obtained by reacting Component A above.

16. The process for making a relief printing plate according to claim 1, wherein the relief printing plate precursor comprises a crosslinked relief-forming layer formed by crosslinking the relief-forming layer comprising the resin composition by heat and/or light.

17. The process for making a relief printing plate according to claim 1, wherein the crosslinking step is a step of crosslinking the relief-forming layer by heat.

18. The process for making a relief printing plate according to claim 1, wherein it further comprises a rinsing step of rinsing the engraved relief layer surface with an aqueous rinsing liquid.

19. The process for making a relief printing plate according to claim 1, wherein the relief layer has a thickness of at least 0.05 mm but no greater than 10 mm.

20. The process for making a relief printing plate according to claim 1, wherein the relief layer has a Shore A hardness of at least 50° but no greater than 90°.
